(19) United States
(12) Patent Application Publication
(10) Pub. No.: US 2026/0228605 A1
(43) Pub. Date: Aug. 6, 2026

(54) MACHINE-LEARNING MODEL SPLITTING

(71) Applicant: QUALCOMM Incorporated, San Diego, CA (US)

(72) Inventors: Abhijit NAVALEKAR, Westford, MA (US); Qi XUE, San Diego, CA (US)

(21) Appl. No.: 19/043,213

(22) Filed: Jan. 31, 2025

(51) Int. Cl. G06N 20/00

(52) U.S. Cl. CPC G06N 20/00

(57) ABSTRACT

Systems and techniques are described herein for processing data. For instance, a method for processing data is provided. The method may include determining a number of processing devices from among a number of available computing devices; dividing a machine-learning model into a number of portions based on the number of processing devices, wherein each portion of the number of portions comprises at least one layer of the machine-learning model; and allocating the number of portions to the number of processing devices for execution.

### FIELD

The present disclosure generally relates to machine learning systems. For example, aspects of the present disclosure relate to systems and techniques for distributing (e.g., dividing or splitting) one or more machine learning (ML) models across one or more distributed artificial intelligence (AI) computing systems.

### BACKGROUND

Recent advancements in AI and ML technologies have led to the development of increasingly sophisticated models capable of understanding and interpreting complex data structures. One class of such models is referred to large generative AI models or large generative machine-learning models (LXMs). LXMs have a multitude of applications that span across various domains, from natural language processing to computer vision and speech recognition. Their efficacy stems from their ability to learn from massive datasets, gaining an unprecedented depth of understanding and applicability.

The increasing capabilities of LXMs, including (but not limited to) Large Language Models (LLMs), Large Speech Models (LSMs), and Large Vision Models (LVMs) (which are also referred to as Language Vision Models or Vision Language Models (VLMs)), offer enhanced functionality in various applications such as natural language understanding, speech recognition, visual analysis, text generation, speech generation, image generation, and/or the like. Among the diverse types of LXMs, LLMs are generally known for their capabilities in understanding and generating human language. These models may be trained on extensive textual datasets and may perform such tasks as machine translation, text summarization, question-answering, and/or the like. LLMs have found applications in a broad range of industries including healthcare, finance, and customer service, among others.

An LSM is a type of LXM specializing in processing and understanding auditory data. LSMs may translate spoken language into textual form and vice versa. LSMs excel at tasks such as speech-to-text conversion, voice recognition, natural language understanding within a spoken context, providing spoken word responses in machine-generated voices, and/or the like. The efficacy of LSMs lies in their capacity to learn from enormous datasets containing diverse accents, dialects, and languages.

An LVM is a LXM that is trained to interpret and analyze visual data. LVM models may use convolutional neural networks or similar architectures to process visual inputs and derive meaningful conclusions from them. From image classification to object detection and generating new images in response to natural language prompts, LVMs are growing in popularity and use in diverse areas such as medical imaging, autonomous vehicles, surveillance systems, advertising, and entertainment.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for processing data. According to at least one example, a method is provided for processing data. The method includes: determining a number of processing devices from among a number of available computing devices; dividing a machine-learning model into a number of portions based on the number of processing devices, wherein each portion of the number of portions comprises at least one layer of the machine-learning model; and allocating the number of portions to the number of processing devices for execution.

In another example, an apparatus for processing data is provided that includes at least one memory and at least one processor (e.g., configured in circuitry) coupled to the at least one memory. The at least one processor configured to: determine a number of processing devices from among a number of available computing devices; divide a machine-learning model into a number of portions based on the number of processing devices, wherein each portion of the number of portions comprises at least one layer of the machine-learning model; and allocate the number of portions to the number of processing devices for execution.

In another example, a non-transitory computer-readable medium is provided that has stored thereon instructions that, when executed by one or more processors, cause the one or more processors to: determine a number of processing devices from among a number of available computing devices; divide a machine-learning model into a number of portions based on the number of processing devices, wherein each portion of the number of portions comprises at least one layer of the machine-learning model; and allocate the number of portions to the number of processing devices for execution.

In another example, an apparatus for processing data is provided. The apparatus includes: means for determining a number of processing devices from among a number of available computing devices; dividing a machine-learning model into a number of portions based on the number of processing devices, wherein each portion of the number of portions comprises at least one layer of the machine-learning model; and allocating the number of portions to the number of processing devices for execution.

In some aspects, one or more of the apparatuses described herein is, can be part of, or can include an extended reality device (e.g., a virtual reality (VR) device, an augmented reality (AR) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a block diagram illustrating an example system for splitting a machine-learning model, according to various aspects of the present disclosure;

FIG. 2 is a component diagram illustrating an example of a distributed AI computing system in accordance with some aspects.

FIG. 3A and FIG. 3B are component block diagrams illustrating examples of a distributed AI computing system in accordance with some aspects.

FIG. 4 is a block diagram illustrating an example neural network architecture suitable for use in accordance with some aspects.

FIG. 5A to FIG. 5F are block diagrams illustrating examples of large generative AI model (LXM) distribution across computing devices of a distributed AI computing system in accordance with some aspects.

FIG. 6A is a block diagram Illustrating LXM input processing in an LXM distribution across computing devices of a distributed AI computing system in accordance with some aspects.

FIG. 6B is a block diagram Illustrating LXM input chunking and chunk parallel processing in an LXM distribution across computing devices of a distributed AI computing system in accordance with some aspects.

FIG. 7A and FIG. 7B are process flow diagrams illustrating example methods of distributing an LXM across computing devices of a distributed AI computing system in accordance with some aspects.

FIG. 7C illustrates an aspect of the subject matter in accordance with one aspect.

FIG. 8A and FIG. 8B are process flow diagrams illustrating an example method of implementing an LXM distributed across a cluster of computing devices in accordance with some aspects.

FIG. 9A to FIG. 9C are process flow diagrams illustrating example methods implementing an LXM distributed across a cluster of computing devices in accordance with some aspects.

FIG. 10 is a flow diagram illustrating an example process for processing data, in accordance with aspects of the present disclosure;

FIG. 11 is a flow diagram illustrating an example process for processing data, in accordance with aspects of the present disclosure;

FIG. 12 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

The terms “computing device,” “user end device” and “end device” may be used herein to refer to (but not limited to) any one or all of personal computing devices, personal computers, workstations, laptop computers, Netbooks, Ultrabook, tablet computers, mobile communication devices, smartphones, user equipment (UE), personal data assistants (PDAs), palm-top computers, wireless electronic mail receivers, multimedia internet-enabled cellular telephones, media and entertainment systems, gaming systems (e.g., PlayStation™, Xbox™, Nintendo switch™), media players (e.g., digital versatile disc (DVD) players, Roku™, apple TV™), digital video recorders (DVRs), portable projectors, 3D holographic displays, wearable devices (e.g., earbuds, smartwatches, fitness trackers, augmented reality (AR) glasses, head-mounted displays, etc.), vehicle systems such as drones, automobiles, motorcycles, connected vehicles, electric vehicles, automotive displays, advanced driver-assistance systems (ADAS), etc., cameras (e.g., surveillance cameras, embedded cameras), smart devices (e.g., smart light bulbs, smartwatches, thermostats, smart glasses, etc.), Internet of Things (IoT) devices, home routers, access points, other similar devices that include communication circuitry and a programmable processor that may be configured to provide the functionality of various aspects.

The term “processing system” is used herein to refer to one more processors, including multi-core processors, which are coupled to at least one memory, organized and configured to perform various computing functions. Various aspect methods may be implemented in one or more of multiple processors within a processing system as described herein.

The term “neural network” is used herein to refer to an interconnected group of processing nodes (or neuron models) that collectively operate as a software application or process that controls a function of a computing device and/or generates an overall inference result as output. Individual nodes in a neural network may attempt to emulate biological neurons by receiving input data, performing simple operations on the input data to generate output data, and passing the output data (also called “activation”) to the next node in the network. Each node may be associated with a weight value that defines or governs the relationship between input data and output data. A neural network may learn to perform new tasks over time by adjusting these weight values. In some cases, the overall structure of the neural network and/or the operations of the processing nodes do not change as the neural network learns a task. Rather, learning is accomplished during a “training” process in which the values of the weights in each layer are determined. As an example, the training process may include causing the neural network to process a task for which an expected/desired output is known, comparing the activations generated by the neural network to the expected/desired output, and determining the values of the weights in each layer based on the comparison results. After the training process is complete, the neural network may begin “inference” to process a new task with the determined weights.

The term “inference” is used herein to refer to a process that is performed at runtime or during the execution of the software application program corresponding to the neural network. Inference may include traversing the processing nodes in the neural network along a forward path to produce one or more values as an overall activation or overall “inference result.”

Machine-learning models can be used to process an input to generate an output. Deep neural networks are an example of machine-learning models. Deep neural networks implement a layered architecture in which the activation of a first layer of nodes becomes an input to a second layer of nodes, the activation of a second layer of nodes becomes an input to a third layer of nodes, and so on. As such, computations in a deep neural network may be distributed over a population of processing nodes that make up a computational chain. Deep neural networks may also include activation functions and sub-functions (e.g., a rectified linear unit that cuts off activations below zero, etc.) between the layers. The first layer of nodes of a deep neural network may be referred to as an input layer. The output layer of nodes may be referred to as an output layer. The layers in-between the input and output layer may be referred to as intermediate layers, hidden layers, or black-box layers.

Each layer in a neural network may have multiple inputs and thus multiple previous or preceding layers. Said another way, multiple layers may feed into a single layer. For ease of reference, some of the aspects are described with reference to a single input or single preceding layer. However, it should be understood that the operations disclosed and described in this application may be applied to each of multiple inputs to a layer and multiple preceding layers.

The term “recurrent neural network” (RNN) is used herein to refer to a class of neural networks particularly well-suited for sequence data processing. Unlike feedforward neural networks, RNNs may include cycles or loops within the network that allow information to persist. This enables RNNs to maintain a “memory” of previous inputs in the sequence, which may be beneficial for tasks in which temporal dynamics and the context in which data appears are relevant.

The term “long short-term memory network” (LSTM) is used herein to refer to a specific type of RNN that addresses some of the limitations of basic RNNs, particularly the vanishing gradient problem. LSTMs include a more complex recurrent unit that allows for the easier flow of gradients during backpropagation. This facilitates the model's ability to learn from long sequences and remember over extended periods, making it apt for tasks such as language modeling, machine translation, and other sequence-to-sequence tasks.

The term “transformer” is used herein to refer to a specific type of neural network that includes an encoder and/or a decoder and can be well-suited for sequence data processing. Transformers may use multiple self-attention components to process input data in parallel rather than sequentially. The self-attention components may be configured to weigh different parts of an input sequence when producing an output sequence. Unlike solutions that focus on the relationship between elements in two different sequences, self-attention components may operate on a single input sequence. The self-attention components may compute a weighted sum of all positions in the input sequence for each position, which may allow the model to consider other parts of the sequence when encoding each element. This may offer advantages in tasks that benefit from understanding the contextual relationships between elements in a sequence, such as sentence completion, translation, and summarization. The weights may be learned during the training phase, allowing the model to focus on the most contextually relevant parts of the input for the task at hand. Transformers, with their specialized architecture for handling sequence data and their capacity for parallel computation, often serve as foundational elements in constructing large generative AI models (LXM).

The term “tensor” is used herein to refer to a vector or array (e.g., multi-dimensional array) that serves as the fundamental building block for various operations within a neural network. Tensors may store numerical values and may exist in multiple dimensions, permitting the encoding of various data types, such as scalars (OD tensors), vectors (1D tensors), matrices (2D tensors), or higher-dimensional arrays. For example, a 3D tensor may store red-green-blue (RGB) color values for a set of images. The dimensions of a tensor may be referred to as “axes,” and the number of axes may be called the “rank” of the tensor. Tensors are commonly used in machine learning and AI technologies for tasks including, but not limited to, data storage, transformation, and optimization. Tensor operations may include mathematical or computational manipulations of tensors, such as element-wise addition, multiplication, tensor contraction, transposition, and other linear transformations. Modern computing devices may include specialized hardware or software components configured to perform tensor operations and efficiently handle these high-dimensional arrays. These components may be included as part of a processing system and/or may include dedicated tensor processing units (TPUs), specialized instruction sets in a central processing unit (CPU), compute unified device architecture (CUDA) cores in a graphics processing unit (GPU), etc.

The term “decoder blocks” is used herein to refer to particular segments or sections within a neural network configured to interpret or translate encoded representations of data into a format more suitable for further processing or direct interpretation. Decoder blocks often work in conjunction with encoder blocks to carry out tasks such as sequence-to-sequence translation, summarization, or other types of transduction tasks. Decoder blocks may generate output sequences based on encoded input sequences and may transform one form of data representation into another. In models such as transformers, decoder blocks typically include layers, also referred to herein using the term “decoder layers,” that utilize features such as multi-headed self-attention, layer normalization, and feed-forward neural networks to convert compressed information back into a usable sequence or structure.

The phrase “tensor at the boundary of decoder blocks” is used herein to refer to specific tensors that exist or are computed at the transitional points between adjacent decoder blocks in a neural network. These tensors may include important information or intermediate representations that are used for the subsequent operations within the next decoder block. The boundary tensors may serve as input or output to particular layers within the decoder blocks and/or may form part of the overall inference operations.

The term “large generative AI model” (LXM) is used herein to refer to an advanced computational framework that includes any of a variety of specialized AI models including, but not limited to, large language models (LLMs), large speech models (LSMs), large/language vision models (LVMs), vision language models (VLMs), hybrid models, and multi-modal models. An LXM may include multiple layers of neural networks (e.g., RNN, LSTM, transformer, etc.) with millions or billions of parameters. Unlike traditional systems that translate user prompts into a series of correlated files or web pages for navigation, LXMs support dialogic interactions and encapsulate expansive knowledge in an internal structure. As a result, rather than merely serving a list of relevant websites, LXMs are capable of providing direct answers and/or are otherwise adept at various tasks, such as text summarization, translation, complex question-answering, conversational agents, etc. In various aspects, LXMs may operate independently as standalone units, may be integrated into more comprehensive systems and/or into other computational units (e.g., those found in a SoC or SIP, etc.), and/or may interface with specialized hardware accelerators to improve performance metrics such as latency and throughput. In some aspects, the LXM component may be enhanced with or configured to perform an adaptive algorithm that allows the LXM to better understand context information and dynamic user behavior. In some aspects, the adaptive algorithms may be performed by the same processing system that manages the core functionality of the LXM and/or may be distributed across multiple independent processing systems.

The terms “local LXM model” may be used to refer to a generative model that is stored on and/or executed by end device(s) and/or in a localized network. Local LXM models may reduce latency, improve efficiency, and help maintain user privacy by reducing or eliminating the need to send information from a user device to external servers for processing.

The term “embedding layer” is used herein to refer to a specialized layer within a neural network, typically at the input stage, which transforms discrete categorical values or tokens into continuous, high-dimensional vectors. An embedding layer may operate as a lookup table in which each unique token or category is mapped to a point in a continuous vector space. The vectors may be refined during the model's training phase to encapsulate the characteristics or attributes of the tokens in a manner that is conducive to the tasks the model is configured to perform.

The term “token” is used herein to refer to a unit of information that an LXM may read as a single input during training and inference. Each token may represent any of a variety of different data types. For example, in text-centric models such as in LLMs, each token may represent a one or more textual element such as a paragraph(s), sentence(s), clause(s), word(s), sub-word(s), character(s), etc. In models designed for auditory data, such as LSMs, each token may represent a feature extracted from audio signals, such as a phoneme, spectrogram, temporal dependency, Mel-frequency cepstral coefficients (MFCCs) that represent small segments of an audio waveform, etc. In visual models such as LVM, each token may correspond to a portion of an image (e.g., pixel blocks), sequences of video frames, etc. In hybrid systems that combine multiple modalities (text, speech, vision, etc.), each token may be a complex data structure that encapsulates information from various sources. For example, a token may include both textual and visual information, each of which independently contributes to the token's overall representation in the model. There are generally limitations on the total number of tokens that may be processed by AI models. As an example, a model with a limitation of 512 tokens may alter or truncate input sequences that go beyond this specific count.

Each token may be converted into a numerical vector by the embedding layer. Each vector component (e.g., numerical value, parameter, etc.) may encode an attribute, quality, or characteristic of the original token. The vector components may be adjustable parameters that are iteratively refined during the model training phase to improve the model's performance during subsequent operational phases. The numerical vectors may be high-dimensional space vectors (e.g., containing more than 300 dimensions, etc.) in which each dimension in the vector captures a unique attribute, quality, or characteristic of the token. For example, dimension 1 of the numerical vector may encode the frequency of a word's occurrence in a corpus of data, dimension 2 may represent the pitch or intensity of the sound of the word at its utterance, dimension 3 may represent the sentiment value of the word, etc. Such intricate representation in high-dimensional space may help the LXM understand the semantic and syntactic subtleties of its inputs. During the operational phase, the tokens may be processed sequentially through layers of the LXM or neural network, which may include structures or networks appropriate for sequence data processing, such as transformer architectures, recurrent neural networks (RNNs), or long short-term memory networks (LSTMs).

Systems, apparatuses, methods (also referred to as processes), and computer-readable media (collectively referred to herein as “systems and techniques”) are described herein for distributed AI computing systems. For example, the systems and techniques described herein may be included in, work in conjunction with, communicate with, provide, and/or otherwise may be associated with a system of distributed AI computing devices. The distributed AI computing devices may be an ecosystem of interconnected components (e.g., computing devices, user devices, etc.) that are configured to extend intelligent, high-performance computing capabilities to end devices and local networks. The distributed AI computing devices may provide, support, or include a standardized and/or unified framework for data collection, task processing, and environment learning. The distributed AI computing devices may support hardware-agnostic platforms equipped with open protocols, application programming interfaces (APIs), and software, enabling the integration of a diverse gamut of devices and systems. The distributed AI computing devices may also support specialized or dedicated hardware arrangements and/or use proprietary protocols, APIs, and software for specialized applications.

Within the distributed AI computing devices framework, a processing system including one or more processors coupled to at least one memory may serve as the computational core of each of the interconnected components. The processing system may perform various operations to implement distributed AI computing devices or manage task execution, resource management, and other functionalities attributed to distributed AI computing devices. In some aspects, the processing system may include an array of microprocessors, memory units, and I/O controllers that are communicatively linked.

A “cluster” may include a group of devices that are locally interconnected. In some aspects, the devices of the cluster may operate under a singular administrative or user domain. Such devices may be connected through local networking technologies, such as Local Area Networks (LAN). A cluster may include both committed and opportunistic computing devices for specialized or general-purpose tasks. Committed devices are those primarily allocated for executing functionalities related to distributed AI computing devices, whereas opportunistic devices lend their excess computational resources when available.

Implementing a machine-learning model (e.g., a large generative machine-learning model (LXM) or other type of machine-learning model) on a computing device may require significant resources of the computing device to achieve required or expected level of performance. For example, an implementation of an LXM in a range of a 10 billion parameter (10B) model on a computing device may require approximately tens of gigabytes of memory, tens to hundreds of gigabytes per second of memory bandwidth, tens of trillions of operations per second (TOPS) of computing capability. For battery powered computing devices, the power cost may be far above typical power consumption for regular use.

The systems and techniques may include and/or enable distributing (e.g., splitting or dividing) a machine-learning model (e.g., an LXM or other type of machine-learning model) across multiple computing devices of a cluster may reduce the amount of resource consumption on a computing device by enabling the multiple computing devices to share the burden of implementing the machine-learning model. While an LXM will be used herein as an illustrative example of a machine-learning model, the systems and techniques can be applied to any type of machine-learning model. Distributing an LXM across multiple computing devices may lower cost of individual computing devices for implementing the LXM while allowing for scaling for implementing larger LXMs distributed across more computing devices. The lower cost of individual computing devices may include reduced per device resource usage and power consumption.

In some aspects, distributing an LXM across multiple computing devices may include dividing the LXM into portions and distributing the portions of the LXM across an initial distributed computing device and one or more distributed computing devices. Distribution of the LXM may include determination of how to divide input layers, decoder layers, or output layers of the LXM into portions and how allocate portions to the computing devices.

Splitting an LXM arbitrarily can results in performance degradation due to increase in token latencies, inefficient distribution of resources on devices, incorrect chunking/batching for prefill and decode phases, selecting incorrect number of devices.

The systems and techniques may adaptively split LXMs. For the splitting, parameters such as number of devices, chunking size and resources utilization on devices may be determined based on a number of devices available for split in each phase, a length of input prompt, an LXM phase (e.g., prefill phase or decode phase), and an LXM model. Additionally, the number of devices may be adapted between prefill and decode phase. The systems and techniques may result in improvement in end-to-end LXM performance by improving the token latency and improved resource utilization across devices.

The systems and techniques may determine how to divide an LXM into portions and/or how to distribute the portions of the LXM based on: a count of the available computing devices (e.g., computing devices available for allocations of portions of the LXM), a length of an input prompt, a phase of the processing (e.g., whether the allocation of portions is for a prefill stage of processing or for a decode phase of processing), characteristics of the LXM, and/or characteristics of the computing devices. For example, there may be a pool of available computing devices to which the systems and techniques may allocate portions of the LXM. Each available of the pool of available computing devices may be available to be used to process data using a portion of the LXM allocated to it. The systems and techniques may determine how to divide an LXM into portions and/or how to distribute portions among the available computing devices based on a count of the number of available computing devices (e.g., in the pool of available computing devices).

Additionally or alternatively, the systems and techniques may be provided with an input prompt. The input prompt may be made up of a number of tokens. For example, the input prompt may be parsed into a number of input tokens (e.g., words, punctuations, portions of words, etc.). The systems and techniques may determine how to divide an LXM into portions and/or how to distribute portions among the available computing devices based on the size of the input prompt (e.g., based on a number of tokens that make up the input prompt).

The LXM may process data in a prefill stage (e.g., processing the input prompt to generate the first output data). Additionally, the LXM may feed the output data to the model to generate a next output data (e.g., predicting a next token, based on the input embedding). In some aspects, the systems and techniques may determine how to divide an LXM into portions and/or how to distribute portions among the available computing devices based on whether the portions are to be used to process data at a prefill stage of operation or a decode phase of operation. Additionally or alternatively, the systems and techniques may determine a different division of the LXM and/or allocation of portions for a prefill stage of operation and for a decode phase of operation of the same LXM.

Characteristics of the LXM may include varying sizes, complexities, and/or parameters. For example, the characteristics of the LXM may include a number of decoder layers, a model dimension size, a number of parameters, a vocabulary size, a max context length, an attention mechanism (e.g., multi-head attention or group query attention), etc. In some aspects, the systems and techniques may determine how to divide an LXM into portions and/or how to distribute portions among the available computing devices based on characteristics of the LXM.

Additionally or alternatively, characteristics of the computing devices may include computing device capability and connectivity conditions between computing devices. For example, computing device capability may include available compute capacity, available memory capacity, available memory bandwidth, available power, etc. of each of the computing devices. As another example, connectivity conditions may include available bandwidth, signal strength, signal quality, signal reliability, signal latency, etc. between the computing devices. In some aspects, the systems and techniques may determine how to divide an LXM into portions and/or how to distribute portions among the available computing devices based on characteristics of the computing devices.

In some aspects, the systems and techniques may determine how to divide an LXM into portions and/or how to distribute portions among the available computing devices to balance execution time between computing devices to which portions of the LXM are allocated. For example, the systems and techniques may divide an LXM into unequal portions based on the processing capabilities of computing devices to which the portions of the LXM are to be allocated. For instance, the systems and techniques may allocate a larger portion of the LXM (e.g., including more layers of the LXM) to a computing device that has greater processing capability and a smaller portion of the LXM (e.g., including fewer layers of the LXM) to a computing device that has less processing capability.

The count of the available computing devices, the computing device capability and/or the connectivity conditions between computing devices may vary over time. In some aspects, the systems and techniques may dynamically redistribute portions of the LXM across the available computing devices. Redistribution of the LXM across the available computing devices may be implemented in a manner similar to a prior distribution of the LXM. In some aspects, the LXM may be redistributed across the same computing devices as the prior distribution. In some aspects, the LXM may be redistributed across different computing devices as compared to a prior distribution. Redistribution of the LXM across different computing devices may be across the initial distributed AI computing device and one or more distributed AI computing devices, where at least one distributed AI computing device is different from the one or more distributed AI computing devices of the prior distribution.

Aspects implementing distribution of an LXM across multiple computing devices may also enable parallelization of data and compute operations for implementing the LXM across the computing devices. Parallelization of operations across the computing devices may be further aided by chunking of inputs to the LXM into input chunks sized based on various parameters.

The systems and techniques may determine how to divide an input into input chunks based on a count of the available computing devices, a length of the input, a phase of the processing, characteristics of the LXM, and/or characteristics of the computing devices. For example, a scheduling device may divide an LXM may into a number of portions. The scheduling device may distribute the LXM to an anchor computing device and a number of non-anchor computing devices. The anchor computing device may operate on input data before non-anchor computing devices. For example, the anchor computing device may be the first device of a chain of devices that may operate on input data to generate output data. The anchor computing device may process the input data to generate processed data. The anchor computing device may provide the processed data to a first non-anchor computing device. The first non-anchor computing device may process the processed data to generate further processed data and provide the further processed data to a second non-anchor computing device. The process may continue through a number of non-anchor computing devices. In some aspects, a last non-anchor computing device of the non-anchor computing devices may generate output data. In other aspects, the last non-anchor computing device may provide the anchor computing device with processed data and the anchor computing device may process the processed data to generate output data.

The chunk size may be communicated to non-anchor computing devices. For example, in cases in which the input or prompt size (or number of tokens) is known by the non-anchor computing devices, the scheduling device can include the chunk size as part of the job/task. As another example, in cases in which the input/prompt size is not known by the non-anchor computing devices, the anchor computing device could either communicate the input size or the chunk size to a subsequent device of the non-anchor computing devices. The subsequent device could similarly communicate the input size or the chunk size to another subsequent device of the non-anchor computing devices. As another example, in cases in which the input/prompt size is not known by the non-anchor devices, the non-anchor computing devices can estimate the chunk size based on the ‘volume’ of data received from the preceding device each chunk/epoch.

The input chunks may be batch processed by the initial distributed AI computing device serially executing one or more input layers and one or more decoder layers of the LXM generating intermediary chunks. The intermediary chunks may be processed by the one or more distributed AI computing devices executing one or more decoder layers.

One or more input chunks may be processed in parallel with transmission of one or more intermediary chunks between computing devices, such as between the initial distributed AI computing devices and a distributed AI computing device or between distributed AI competing devices. The one or more input chunks may also be processed in parallel with processing of the one or more intermediary chunks by one or more distributed AI computing devices. Similarly, the one or more intermediary chunks may be processed in parallel with transmission of one or more other intermediary chunks between distributed AI computing devices. The one or more intermediary chunks may also be processed in parallel with processing of the one or more other intermediary chunks by one or more other distributed AI computing devices.

Parallel processing of chunked inputs by multiple computing devices implementing the distributed LXM may improve end to end LXM performance in terms of token latency in comparison to serial processing of whole inputs within a single device. Such aspects may also reduce a total cost of ownership (TOC) of individual computing devices of for implementing an LXM by reducing reliance on dedicated central AI hardware of a single computing device by opportunistically leveraging available distributed hardware of distributed AI computing devices.

An initial distributed AI computing device may orchestrate resource management within and in between clusters. The initial distributed AI computing device may dynamically distribute resources and tasks among devices based on parameters such as device capabilities, existing device workloads, task priority, task urgency, task complexity, etc. The initial distributed AI computing device may allow the dynamic addition or removal of devices or clusters in response to changing resource availability and/or changing computational demands. The initial distributed AI computing device may also consider the communication topology and conditions when making decisions about where to distribute workloads.

To improve performance of a split LXM, the systems and techniques may determine a prefill chunk size. The systems and techniques may determine the prefill chunk size depending on the number of devices available and the input prompt size. Additionally or alternatively, the systems and techniques may determine the decode chunk size based on the number of devices available and if speculative decoding has been enabled or not. The chunk size between prefill and decode phase can be different. In the event that the input length is not known when the systems and techniques determine the chunk sizes, a lookup table can be populated for different set of possible input lengths vs chunk sizes.

Additionally or alternatively, the systems and techniques may adjust the allocation of layers between the devices based on scheduling design. The systems and techniques may change the number of devices between prefill and decode phases. For example, the prefill phase of operation of the LXM may run on M devices while decode phase of operation of the LXM runs on N devices.

Additionally or alternatively, to determine and/or implement the split, the systems and techniques may implement on-demand key value (KV) cache generation on an anchor device and/or designated devices. The systems and techniques may cause the devices to exchange KV caches between participating devices.

Various aspects of the application will be described with respect to the figures below.

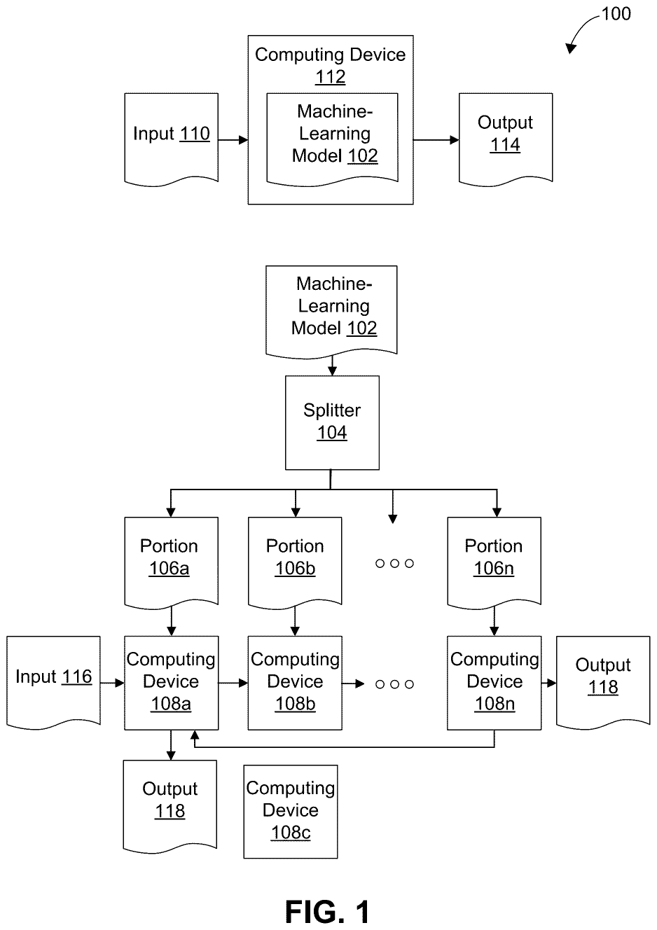

FIG. 1 is a block diagram illustrating an example system 100 for splitting a machine-learning model 102, according to various aspects of the present disclosure. Machine-learning model 102 may be, or may include, large generative AI model or a large generative machine-learning model (LXM). For example, machine-learning model 102 may be, or may include, a Large Language Model (LLM), a Large Speech Model (LSM), or a Large Vision Model (LVM) (which are also referred to as Language Vision Models or Vision Language Models (VLMs)).

Machine-learning model 102 may be a machine-learning model trained to generate (when executed on a computing device 112) output 114 based on input 110. Input 110 may be a text prompt or query. Input 110 may additionally include conditions. Output 114 may be any form of data, such as image data, video data, audio data, numerical data, etc.

Splitter 104 may split machine-learning model 102 into portions to be executed by selected computing devices of a pool of available computing devices. For example, splitter 104 may divide machine-learning model 102 into portion 106a, portion 106b, portion 106n, to be run by computing device 108a, computing device 108b, and computing device 108n respectively. Splitter 104 may determine to split machine-learning model 102 into portion 106a, portion 106b, and portion 106n based on having selected to run portion 106a, portion 106b, and portion 106n using computing device 108a, computing device 108b, and computing device 108n from among a pool of computing devices including computing device 108a, computing device 108b, computing device 108n and computing device 108c.

According to various aspects of the present disclosure, splitter 104 may split machine-learning model 102 based on a number of devices available for running portions of machine-learning model 102 (e.g., computing device 108a, computing device 108b, computing device 108n, and computing device 108n), a length of input prompt (e.g., a length of input 116), an LXM phase (e.g., prefill phase or decode phase), and an LXM model (e.g., a characteristic of machine-learning model 102). Splitter 104 may determine to use a different number of available computing devices for running portions for the prefill phase and the decode phase. Accordingly, splitter 104 may split machine-learning model 102 into different portions for processing data at a prefill phase and at a decode phase. System 100 may improve in end-to-end LXM performance by improving the token latency and improved resource utilization across devices.

Computing device 108a may run portion 106a, computing device 108b may run portion 106b, and computing device 108n may run portion 106n to process input 116 to generate output 118. For example, computing device 108a may receive input 116 and run portion 106a to generate a first intermediate output. Computing device 108b may receive the first intermediate output and run portion 106b to generate a second intermediate output. Computing device 108n may receive an nth intermediate output and run portion 106n to generate output 118.

The processing of computing device 108a, computing device 108b, and computing device 108n to generate output 118 based on input 116 may be similar to the processing of input 110 to generate output 114. For example, if input 110 and input 116 are the same, output 118 may be similar to output 114.

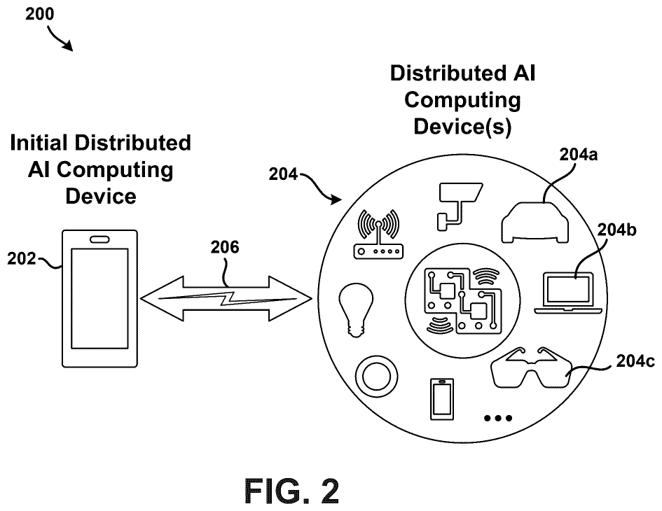

In some aspects, computing device 108a may implement splitter 104. For example, the operations described with regard to splitter 104 may be performed by computing device 108a. In some aspects, computing device 108a may be an “anchor” computing device or an “initial” computing device (e.g., as described with regard to FIG. 2). In some aspects, computing device 108a may generate output 118. For example, computing device 108n may process data and provide the processed data to computing device 108a. Computing device 108a may process the processed data to generate output 118. FIG. 2 is a component diagram illustrating an example of a distributed AI computing system 200 in accordance with some aspects. With reference to FIG. 2, the distributed AI computing system 200 may be a cluster of computing devices and include an initial distributed AI computing device 202 and one or more distributed AI computing devices 204. The initial distributed AI computing device 202 may include any computing device having at least a user interface, a processor system and a wireless transceiver. A distributed AI computing devices 204 may be any computing device having at least a processor and a wireless tr.

The initial distributed AI computing device 202 and one or more distributed AI computing devices 204 may be communicatively linked via their wireless transceivers over one or more wireless communications networks 206 or via a wired network, such as an Ethernet network, an optical fiber network, or a high bandwidth memory (HBM) network (not illustrated in FIG. 2). As such, in the present disclosure, the term “transmit” and like terms may refer to wireless transmission of signals encoding data and/or wired transmission of signals encoding data. The wireless communication networks 206 may include a personal area network (PAN), a local area network (LAN), a wide local area network (WLAN), a wide area network (WAN), etc. The initial distributed AI computing device 202 and the one or more distributed AI computing devices 204 may communicate via one or more communication protocols. The communication protocols may include wireless communication protocols, mobile/cellular communication protocols, internet protocols, Internet of Things (IoT) communication protocols, etc. The initial distributed AI computing device 202 may be communicatively linked with and communicate with any two or more distributed AI computing devices 204 via the same or different wireless communications networks 206 and communication protocols.

In some aspects, two or more distributed AI computing devices 204 may be communicatively linked via their wireless transceivers over one or more wireless communications networks 206. The wireless communications networks 206 may include a PAN, a LAN, a WLAN, a WAN, etc. The two or more distributed AI computing devices 204 may communicative via one or more communication protocols. The communication protocols may include wireless communication protocols, mobile/cellular communication protocols, internet protocols, IoT communication protocols, etc. Any distributed AI computing device 204 may be communicatively linked with and communicate with the initial distributed AI computing device 202 and any one or more distributed AI computing devices 204 via the same or different wireless communications networks 206 and communication protocols.

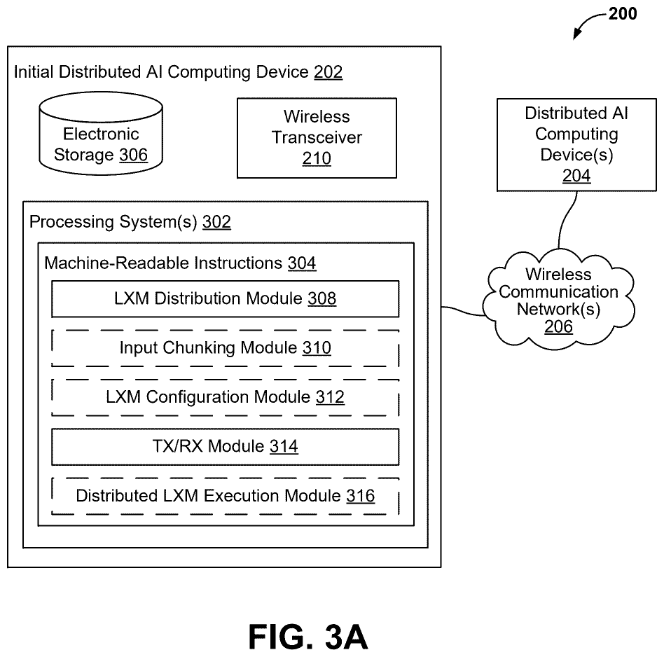

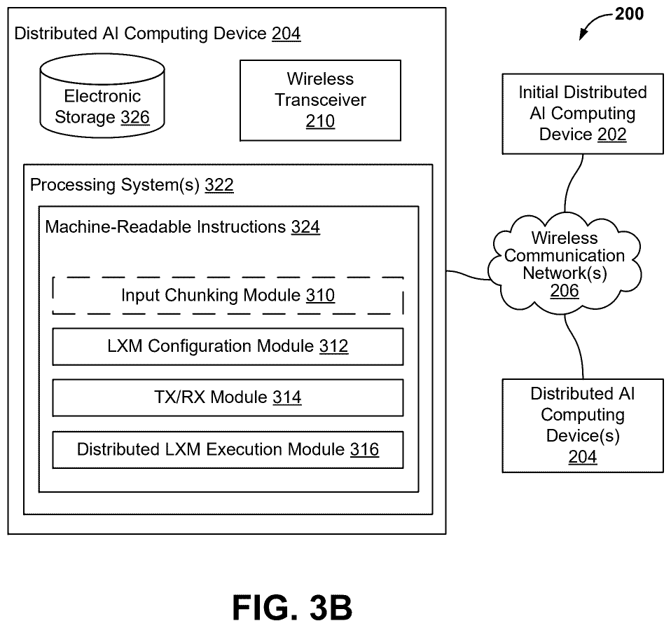

FIG. 3A and FIG. 3B are component block diagrams illustrating an example of the distributed AI computing system 200 in accordance with some aspects. With reference to FIG. 2, FIG. 3A, and FIG. 3B, distributed AI computing system 200 may include the initial distributed AI computing devices 202 and the one or more distributed AI computing devices 204. The computing devices 202, 204 may each include one or more processing systems 302, 322 coupled to electronic storage 306, 326 (e.g., a memory) and a wireless transceiver.

Referring to the initial distributed AI computing device 202, the processing system(s) 302 may be configured by machine-readable instructions 304. Machine-readable instructions 304 may include one or more instruction modules 308-316. The instruction modules 308-316 may include computer program modules. In some aspects, the functions of the instruction modules 308-316 may be implemented in software, firmware, hardware (e.g., circuitry), or a combination of software and hardware, which are configured to perform particular operations or functions. The instruction modules 308-316 may include one or more of an LXM distribution module 308, optionally an input chunking module 310, optionally an LXM configuration module 312, a transmit/receive (TX/RX) module 314, optionally a distributed LXM execution module 316, or other instruction modules.

The LXM distribution module 308 may be configured to determine how to distribute an LXM across multiple computing devices, including any combination of the computing devices 202, 204. LXM distribution module 308 may determine how to divide the LXM into portions and/or how to allocation the portions to computing devices (e.g., initial distributed AI computing device 202 and distributed AI computing devices 204) based on: a count of the available computing devices, a length of an input, a phase of the processing, characteristics of the LXM, and/or characteristics of the computing devices. For example, LXM distribution module 308 may divide the LXM into multiple portions and allocate the portions to the computing devices 202, 204 based on: the count of the available computing devices, the length of the input, the phase of the processing, characteristics of the LXM, and/or characteristics of the computing devices. Each portion of the LXM may include at least one input layer, decoder layer, and/or output layer of the LXM.

There may be a pool of available computing devices (e.g., a pool of distributed AI computing devices 204) to which LXM distribution module 308 may allocate portions of the LXM. Each available of the pool of available computing devices may be available to be used to process data using a portion of the LXM allocated to it. LXM distribution module 308 may determine how to divide an LXM into portions and/or how to distribute portions among the available computing devices based on a count of the number of available computing devices (e.g., in the pool of available computing devices).

The LXM may be provided with an input prompt. The input prompt may be made up of a number of tokens. For example, the input prompt may be parsed into a number of input tokens (e.g., words, punctuations, portions of words, etc.). LXM distribution module 308 may determine how to divide an LXM into portions and/or how to distribute portions among the available computing devices based on the size of the input prompt (e.g., based on a number of tokens that make up the input prompt).

The LXM may process data in a prefill stage (e.g., encoding the input prompt to generate an input embedding). Additionally, the LXM may process the input embedding to generate output data (e.g., predicting a next token, based on the input embedding). In some aspects, LXM distribution module 308 may determine how to divide an LXM into portions and/or how to distribute portions among the available computing devices based on whether the portions are to be used to process data at a prefill stage of operation or a decode phase of operation. Additionally or alternatively, LXM distribution module 308 may determine a different division of the LXM and/or allocation of portions for a prefill stage of operation and for a decode phase of operation of the same LXM.

Characteristics of the LXM may include varying sizes, complexities, and/or parameters. For example, the characteristics of the LXM may include a number of decoder layers, a model dimension size, a number of parameters, a vocabulary size, a max context length, an attention mechanism (e.g., multi-head attention or group query attention), etc. In some aspects, LXM distribution module 308 may determine how to divide an LXM into portions and/or how to distribute portions among the available computing devices based on characteristics of the LXM.

Additionally or alternatively, characteristics of the computing devices (e.g., of initial distributed AI computing device 202 and/or distributed AI computing devices 204) may include computing device capability and connectivity conditions between computing devices. For example, computing device capability may include available compute capacity, available memory capacity, available memory bandwidth, available power, etc. of each of the computing devices. As another example, connectivity conditions may include available bandwidth, signal strength, signal quality, signal reliability, signal latency, etc. between the computing devices. In some aspects, LXM distribution module 308 may determine how to divide an LXM into portions and/or how to distribute portions among the available computing devices based on characteristics of the computing devices. Additionally or alternatively, LXM distribution module 308 can also determine and a key and value tensors (key and value tensors may be referred to as “KV$”) sharing mode. For example, LXM distribution module 308 may determine if KV$ should be shared explicitly or shared as embeddings. Additionally or alternatively, LXM distribution module 308 may determine at which stage KV$ may be shared and/or source-destination pairs for sharing.

In some aspects, LXM distribution module 308 may identify, such as by estimation or calculation, a time for implementing one or more input layers, decoder layers, or output layers for each computing device 202, 204. The time for implementing one or more input layers, decoder layers, or output layers for any of the computing devices 202, 204 may be based on the characteristics of the computing device 202, 204 and/or of the LXM. For example, the time for implementing one or more input layers, decoder layers, or output layers which may be referred to as a token latency, may be a combination of a memory I/O latency, a compute latency, and a transmission latency. The memory I/O latency may be for loading weights & key values of the one or more input layers, decoder layers, or output layers and may be identified, for example, based on an available memory bandwidth of the computing device 202, 204. The compute latency may be for generating tokens over the one or more input layers, decoder layers, or output layers and may be identified, for example, based on an available compute capacity of the computing device 202, 204. The transmission latency for transmitting tokens between computing devices 202, 204 and may be identified, for example, based on connectivity conditions between computing devices 202, 204.

Using the time for executing one or more input layers, decoder layers, or output layers for each computing device 202, 204, LXM distribution module 308 may identify how many input layers, decoder layers, or output layers each computing device 202, 204 may implement while balancing execution time the LXM, or the input layers, decoder layers, or output layers, across the computing device 202, 204. Similarly, LXM distribution module 308 may identify which input layers, decoder layers, or input layers each computing device 202, 204 may be allocated to implement while balancing execution time of the LXM, or the input layers, decoder layers, or output layers, across the computing device 202, 204. In some aspects, balancing execution time of the LXM, or the input layers, decoder layers, or output layers, across the computing device 202, 204 may include each of the computing devices 202, 204 taking approximately the same amount of time implementing allocated input layers, decoder layers, or output layers.

The input layers, decoder layers, and/or output layers to be allocated to a computing device 202, 204 may be collectively referred to as a portion of the LXM. LXM distribution module 308 may generate information configured to indicate to computing devices 202, 204 the portions of the LXM allocated to the computing devices 202, 204.

In some aspects, LXM distribution module 308 may be continuously, periodically, or episodically implemented. LXM distribution module 308 may be executed during implementation of an LXM across the computing devices 202, 204. Additionally or alternatively, LXM distribution module 308 may dynamically redistribute the LXM across computing devices 202, 204 during the implementation of the LXM.

A total time for implementing the decoder phase of the LXM across the computing devices 202, 204, which may also be referred to as a token latency, may be based on a combination of the time for each computing device 202, 204 to implement the allocated portions. The token latency may be calculated, for example, based on memory I/O latency, compute latency, and transmission latency of the computing devices 202, 204.

Input chunking module 310 may be optionally included on or executed by the initial distributed AI computing device 202. For example, input chunking module 310 may be included on or executed by the initial distributed AI computing device 202 for aspects in which the initial distributed AI computing device 202 may implement an input layer or a portion of the LXM. For another example, input chunking module 310 may be included on or executed by the initial distributed AI computing device 202 for aspects in which the distributed AI computing devices 204 do not implement a chunking module 310.

Input chunking module 310 may be configured to identify an input chunk size and divide input tokens to the LXM into input chunks of the input chunk size. The input chunk size may be identified based on a count of the available computing devices, a length of an input, a phase of the processing, characteristics of the LXM, and/or characteristics of the computing devices.

In some aspects, the input chunking module 310 may identify, such as by estimation or calculation, a metric for implementing the distributed LXM across the computing device 202, 204. The input chunk size may be identified to achieve various metrics. For example, input chunk size may be identified to achieve reduced token latency. Reduced token latency may be reduced relative to implementation of the LXM on a single computing device 202, 204 or multiple computing devices 202, 204 using an undivided, or whole, input to the LXM. The token latency may be calculated, for example, based on memory I/O latency, compute latency, and transmission latency of the computing devices 202, 204 for one or more input chunk sizes.

Based on the identification of an input chunk size, input chunking module 310 may divide an input to the LXM into input chunks of the input chunk size. In some aspects, the input chunk size may be static or dynamic, based on different scenarios and requirements like multi-user support.

In some aspects, input chunking module 310 may be continuously, periodically, or episodically implemented. Input chunking module 310 may be executed during implementation of an LXM across the computing devices 202, 204. Additionally or alternatively, input chunking module 310 may dynamically reidentify an input chunk size and divide a remaining part of the input token during the implementation of the LXM.

The distributed LXM configuration module 312 may be optionally included on or executed by the initial distributed AI computing device 202. For example, the distributed LXM configuration module 312 may be included on or executed by the initial distributed AI computing device 202 for aspects in which the initial distributed AI computing device 202 may implement a portion of the LXM. Distributed LXM configuration module 312 may configure the initial distributed AI computing device 202 to implement the distributed LXM. Distributed LXM configuration module 312 may configure the processor system 302 and/or the distributed LXM execution module 316 to implement the portion of the LXM allocated to the initial distributed AI computing device 202 and not other portions of the distributed LXM. For example, distributed LXM configuration module 312 may provide an indication of to the portion of the LXM allocated to the initial distributed AI computing device 202 to the processor system 302 and/or distributed LXM execution module 316 directly, via a stored value, such as at the electronic storage 306, a register, etc.

Distributed LXM execution module 316 may be optionally included on or executed by the initial distributed AI computing device 202. For example, distributed LXM execution module 316 may be included on or executed by the initial distributed AI computing device 202 for aspects in which the initial distributed AI computing device 202 may implement at least part of the LXM. The distributed LXM execution module 316 may be configured to implement the distributed LXM on the initial distributed AI computing device 202. Based on a configuration of the distributed LXM execution module 316, implementing the distributed LXM on the initial distributed AI computing device 202 may include implementing one or more input layers, one or more decoder layers, and/or one or more output layers of the distributed LXM. For example, the distributed LXM execution module 316 may be configured to implement one or more input layers, such as during a prefill phase. As another example, the distributed LXM execution module 316 may be configured to implement one or more input layers and/or one or more output layers. As another example, the distributed LXM execution module 316 may be configured to dynamically change layer mapping between computing devices 202, 204. Based on the indication of the portion of the distributed LXM allocated to the initial distributed AI computing device 202 provided by the distributed LXM configuration module 312, the distributed LXM execution module 316 may implement the allocated portion, including one or more input layers, one or more decoder layers, and/or one or more output layers.

The distributed LXM execution module 316 may may batch process each input chunk of an input token of the input chunk size provided from the input chunking module 310. Distributed LXM execution module 316 may serially implement the layers of the LXM that distributed LXM execution module 316 is configured to implement. For example, distributed LXM execution module 316 may implement the one or more input layers and/or the one or more decoder layers for a first input chunk to generate a first intermediary chunk. In parallel with TX/RX module 314 transmitting the first intermediary chunk to a distributed AI computing device 204, distributed LXM execution module 316 may implement the one or more input layers and/or the one or more decoder layers for a second input chunk to generate a second intermediary chunk. Distributed LXM execution module 316 may also implement the one or more input layers and/or the one or more decoder layers for the second input chunk in parallel with one or more distributed AI computing devices 204 implementing the distributed LXM for the first intermediary chunk. The distributed LXM execution module 316 may continue to process subsequent input chunks of input tokens in parallel with the transmission of previous intermediary chunks by TX/RX module 314.

In some aspects, the distributed LXM execution module 316 may also implement one or more output layers to generate an output chunk. For example, distributed LXM execution module 316 may implement the one or more output layers for a first input chunk to generate a third intermediary chunk received from a distributed AI computing device 204 via TX/RX module 314. In parallel with TX/RX module 314 receiving a subsequent fourth intermediary chunk, distributed LXM execution module 316 may implement the one or more output layers for the third intermediary chunk to generate an output chunk. Distributed LXM execution module 316 may continue to process subsequent intermediary chunks in parallel with receiving of later intermediary chunks by TX/RX module 314. In some aspects, distributed LXM execution module 316 may assemble the output chunks derived from the input chunks of an input token into an output probability or output tensor.

TX/RX module 314 may be configured to receive the characteristics of one or more distributed AI computing devices 204 and provide the characteristics to LXM distribution module 308 and input chunking module 310. TX/RX module 314 may also be configured to transmit which portions of the LXM are identified and allocated to the one or more distributed AI computing devices 204 by LXM distribution module 308 to the one or more distributed AI computing devices 204. In some aspects, TX/RX module 314 may also be configured to transmit input chunks of input tokens generated by input chunking module 310 or intermediary chunks generated by distributed LXM execution module 316 to the one or more distributed AI computing devices 204. In some aspects, TX/RX module 314 may be configured to receive a prompt configured to trigger implementation of the distributed LXM and provide the prompt and/or input to distributed LXM execution module 316. In some aspects, TX/RX module 314 may be configured to receive the input token from the client application and provide the input to the input chunking module 310. In some aspects, the client application may be implemented on any of the computing devices 202, 204 or another computing device (not shown) connected to the initial distributed AI computing device 202 via the one or more wireless communication networks 206. In some aspects, TX/RX module 314 may be configured to receive output chunks, or output tensors, from one or more one or more distributed AI computing devices 204. In some aspects, TX/RX module 314 may be configured to provide the output chunks, or output tensors, to the client application.

Referring to the one or more distributed AI computing devices 204, the processing system(s) 322 may be configured by machine-readable instructions 324. Machine-readable instructions 324 may include one or more instruction modules 310-316. The instruction modules 310-316 may include computer program modules. In some aspects, the functions of the instruction modules 310-316 may be implemented in software, firmware, hardware (e.g., circuitry), or a combination of software and hardware, which are configured to perform particular operations or functions. The instruction modules 310-316 may include one or more of input chunking module 310, LXM configuration module 312, TX/RX module 314, distributed LXM execution module 316, or other instruction modules.

Input chunking module 310 may be optionally included on or executed by the distributed AI computing device 204. For example, input chunking module 310 may be included on or executed by the distributed AI computing device 204 for aspects in which the initial distributed AI computing device 202 or other distributed AI computing devices 204 do not implement an input chunking module 310. Input chunking module 310 may be implemented by processing system 322 in a similar manner as described herein for the processing system 302 of initial distributed AI computing device 202. In some aspects, TX/RX module 314 may be configured to receive an input token from a client application and provide the input to the input chunking module 310. In some aspects, the client application may be implemented on any of the computing devices 202, 204 or another computing device (not shown) connected to the distributed AI computing device 204 via the one or more wireless communication networks 206.

TX/RX module 314 may be configured to transmit the characteristics of the one or more distributed AI computing devices 204 to the initial distributed AI computing device 202. TX/RX module 314 may also be configured to receive which portions of the LXM are allocated to the one or more distributed AI computing devices 204 from the initial distributed AI computing device 202 and provide which portions of the LXM are allocated to the one or more distributed AI computing devices 204 to LXM configuration module 312.

Distributed LXM configuration module 312 may configure the one or more distributed AI computing devices 204 to implement the distributed LXM. The distributed LXM configuration module 312 may configure processor system 322 and/or distributed LXM execution module 316 to implement the portion of the LXM allocated to the one or more distributed AI computing devices 204 and not other portions of the distributed LXM. For example, the distributed LXM configuration module 312 may provide an indication of the portion of the LXM allocated to the one or more distributed AI computing devices 204 to processor system 322 and/or distributed LXM execution module 316 directly, via a stored value, such as at the electronic storage 326, a register, etc.

TX/RX module 314 may also be configured to receive intermediary chunks from the one or more of the computing devices 202, 204 and provide the intermediary chunks to the distributed LXM execution module 316.

The distributed LXM execution module 316 may be configured to implement the distributed LXM on the one or more distributed AI computing devices 204. Based on a configuration of distributed LXM execution module 316, implementing the distributed LXM on the one or more distributed AI computing devices 204 may include implementing one or more input layers, one or more decoder layers, and/or one or more output layers of the distributed LXM. Based on the indication of the portion of the distributed LXM allocated to the one or more distributed AI computing devices 204 provided by distributed LXM configuration module 312, distributed LXM execution module 316 may implement the allocated portion, including one or more input layers, decoder layers, or output layers. In some aspects, distributed LXM execution module 316 may implement the one or more input layers in a similar manner as described herein for the processing system 302 of the initial distributed AI computing device 202.

Distributed LXM execution module 316 may serially receive intermediary chunks from one or more computing devices 202, 204 and serially implement the layers of the LXM that the distributed LXM execution module 316 is configured to implement. For example, the one or more computing devices 202, 204 may implement the distributed LXM for a first input chunk or a first intermediary chunk and may generate a second intermediary chunk. Distributed LXM execution module 316 may implement the one or more decoder layers for the second intermediary chunk to generate a third intermediary chunk. Distributed LXM execution module 316 may be implemented for the second intermediary chunk in parallel with distributed LXM implementation of the one or more computing devices 202, 204 for a second input chunk or a fourth intermediary chunk. Further, in parallel with TX/RX module 314 transmitting the third intermediary chunk to one or more computing devices 202, 204, distributed LXM execution module 316 may implement the one or more decoder layers for the fourth intermediary chunk to generate a fifth intermediary chunk. Distributed LXM execution module 316 may also implement the one or more decoder layers for the fourth intermediary chunk in parallel with one or more distributed AI computing device 204 implementing the distributed LXM for the third intermediary chunk.

As another example, the one or more computing devices 202, 204 may implement the distributed LXM for a first input chunk or a first intermediary chunk and may generate a second intermediary chunk. Distributed LXM execution module 316 may implement the one or more decoder layers and out or more output layers for the second intermediary chunk to generate a first output chunk. Distributed LXM execution module 316 may be implemented for the second intermediary chunk in parallel with distributed LXM implementation of the one or more computing devices 202, 204 for a second input chunk or a third intermediary chunk. Further, in parallel with TX/RX module 314 transmitting the first output chunk to the initial distributed AI computing device 204, the distributed LXM execution module 316 may implement the one or more decoder layers and the one or more output layers for the third intermediary chunk to generate a second output chunk. In some aspects, distributed LXM execution module 316 may assemble the output chunks derived from the input chunks of an input token into an output probability or output tensor.

Distributed LXM execution module 316 may continue to process subsequent intermediary chunks in parallel with the transmission of previous intermediary chunks or output chunks by TX/RX module 314.

In some aspects, TX/RX module 314 may also be configured to transmit intermediary chunks generated by distributed LXM execution module 316 to one or more distributed AI computing devices 204 and/or to the initial distributed AI computing device 202. In some aspects TX/RX module 314 may also be configured to transmit output chunks or output tensors generated by distributed LXM execution module 316 to the initial distributed AI computing device 202. In some aspects, TX/RX module 314 may be configured to provide the output chunks, or output tensors, to the client application.

The wireless transceiver 210 may be configured to transmit and receive radio signals transmitted between the computing devices 202, 204 via the one or more wireless communication networks 206. The wireless transceiver 210 may convert digital signals provided from the processing system(s) 302, 322 to radio signals for transmission and convert radio signals received from the one or more wireless communications network(s) to digital signals for the processing system(s) 302, 322.

Electronic storage 306, 326 may include non-transitory storage media that electronically stores information. The electronic storage media of electronic storage 306, 326 may include one or both of system storage that is provided integrally (i.e., substantially non-removable) with the computing devices 202, 204 and/or removable storage that is removably connectable to the computing devices 202, 204 via, for example, a port (e.g., a universal serial bus (USB) port, a firewire port, etc.) or a drive (e.g., a disk drive, etc.). Electronic storage 306, 326 may include one or more of optically readable storage media (e.g., optical disks, etc.), magnetically readable storage media (e.g., magnetic tape, magnetic hard drive, floppy drive, etc.), electrical charge-based storage media (e.g., Electrically-Erasable Programmable Read-Only Memory (EEPROM), random-access memory (RAM), etc.), solid-state storage media (e.g., flash drive, etc.), and/or other electronically readable storage media. Electronic storage 306, 326 may include one or more virtual storage resources (e.g., cloud storage, a virtual private network, and/or other virtual storage resources). Electronic storage 306, 326 may store software algorithms, information determined by processing system(s) 302, 322, information received from the computing devices 202, 204 or other information that enables the computing devices 202, 204 to function as described herein. For example, the electronic storage 306, 326 may store the modules 308-316.

Processing system(s) 302, 322 may be configured to provide information processing capabilities in the computing devices 202, 204. As such, the processing system(s) 302, 322 may include one or more of a digital processor, an analog processor, a digital circuit designed to process information, an analog circuit designed to process information, a state machine, and/or other mechanisms for electronically processing information. Although the processing system(s) 302, 322 are illustrated as single entities, this is for illustrative purposes only. In some aspects, the processing system(s) 302, 322 may include a plurality of processing units and/or processor cores. The processing units may be physically located within the same device, or processing system(s) 302, 322 may represent processing functionality of a plurality of devices operating in coordination. The processing system(s) 302, 322 may be configured to execute modules 308-316 and/or other modules by software; hardware; firmware; some combination of software, hardware, and/or firmware; and/or other mechanisms for configuring processing capabilities on processing system(s) 302, 322. As used herein, the term “module” may refer to any component or set of components that perform the functionality attributed to the module. This may include one or more physical processors during execution of processor readable instructions, the processor readable instructions, circuitry, hardware, storage media, or any other components.

The description of the functionality provided by the different modules 308-316 is for illustrative purposes, and is not intended to be limiting, as any of modules 308-316 may provide more or less functionality than is described. For example, one or more of the modules 308-316 may be eliminated, and some or all of its functionality may be provided by other modules 308-316. As another example, the processing system(s) 302, 322 may be configured to execute one or more additional modules that may perform some or all of the functionality attributed below to one of the modules 308-316.

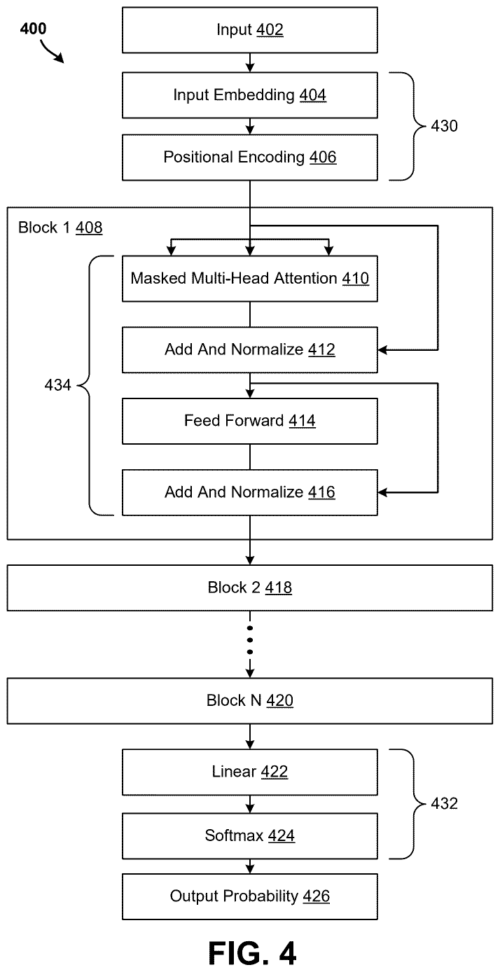

FIG. 4 is a block diagram illustrating an example neural network architecture 400 suitable for use in accordance with some aspects. With reference to FIG. 2 to FIG. 4, neural network architecture 400 may be an LXM (which may also be referred to as “LXM 400”) that may be implemented on one or more processing systems (e.g., processing system 302, 322 of FIG. 3A and FIG. 3B) on one or more computing devices (e.g., computing device 202, 204 of FIG. 2 to FIG. 3B). Neural network architecture 400 of FIG. 4 may be an example of an LXM, such as an LLM, or any other type of LXM.

LXM 400 may include one or more input layers 430, multiple decoder layers 434, and one or more output layers 432. The one or more input layers 430 may include, for example, an input embedding layer 404 and/or a positional encoding layer 406. The one or more output layers 432, may include, for example, a linear layer 422, and/or a softmax layer 424. The softmax function is a function that turns a vector of K real values into a vector of K real values that sum to 1. The input values can be positive, negative, zero, or greater than one, but the softmax transforms them into values between 0 and 1, so that they can be interpreted as probabilities.

The one or more decoder layers 434 may be grouped into one or more decoder blocks 408, 418, 420. Each decoder block 408, 418, 420 may include the same or different decoder layers 434. The decoder layers 434 may include, for example, one or more of any combination of a masked multi-head attention layer 410, add and normalization layer 412, 416, and/or feed forward layer 414.

The LXM 400 may receive an input 402 into the one or more input layers 430. The input 402 may be any form of data including data representing text, images, video, sound, etc. The input 402 may be divided into input chunks of an input chunk size such that the input 402 is divided into smaller, sequential parts. The input 402 may be provided as sequential input chunks, such that each input chunk may be an input 402, to the LXM 400. The input embedding layer 404 may convert the input 402 into a data format, such as vectors, that the LXM 400 may process. The positional encoding layer 406 may add information about the position of aspects of the input 402 in a sequence that may aid the LXM 400 understand the order of the aspects of the input 402.

The input chunks processed by the input layers 430 may be provided to the decoder layers 434 and/or decoder blocks 408, 418, 420. The masked multi-head attention layer 410 may implement various different functions on the input 402 and combine the results while masking future chunks from the functions. The add and normalization layer 412 may normalize the input 402 and add residual connections that may maintain a consistent scale of the data. The feed forward layer 414 may apply a fully connected neural network to the different aspects of the input 402. The add and normalization layer 416 may again normalize the input 402 and add residual connections that may maintain a consistent scale of the data. The output of any of the decoder layers 434 and/or decoder blocks 408, 418, 420 may be referred to as an intermediary chunk.

The output of the final decoder layers 434 and/or decoder block 420, intermediary chunks, may be provided to the output layers 432. The linear layer 422 may apply a linear transformation to the intermediary chunks. The softmax layer 424 may convert the result of the linear functions into probabilities 426. The output of any of the output layers 432 may be referred to as an output chunk.

The layers 404-424 are used for illustrative purposes and do not limit the input layers 430, decoder layers 434, and output layers 432 to these specific examples. It should be understood that the input layers 430, decoder layers 434, and output layers 432 may include various other combinations of layers for other configurations of the LXM 400.

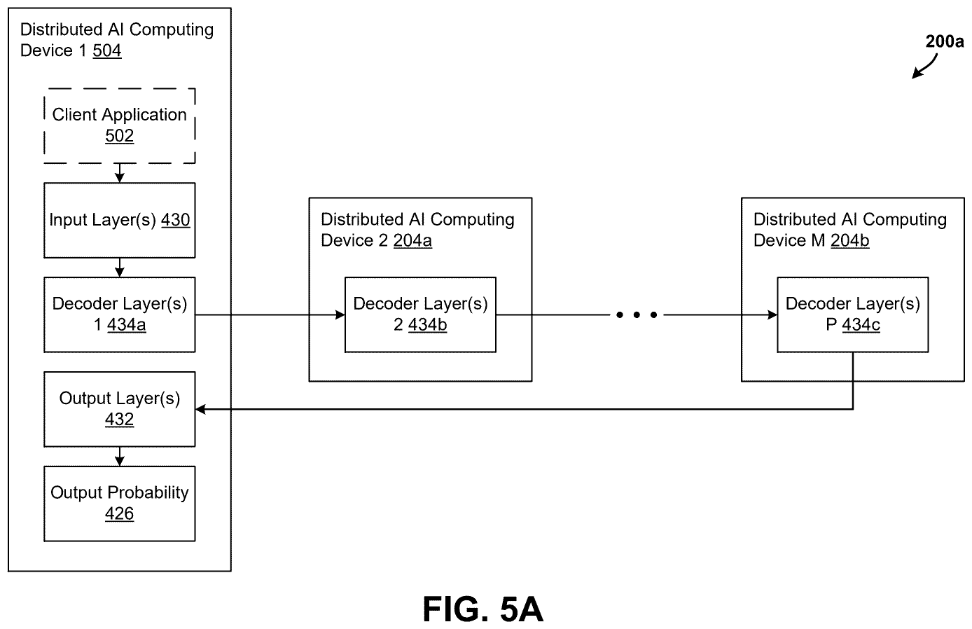

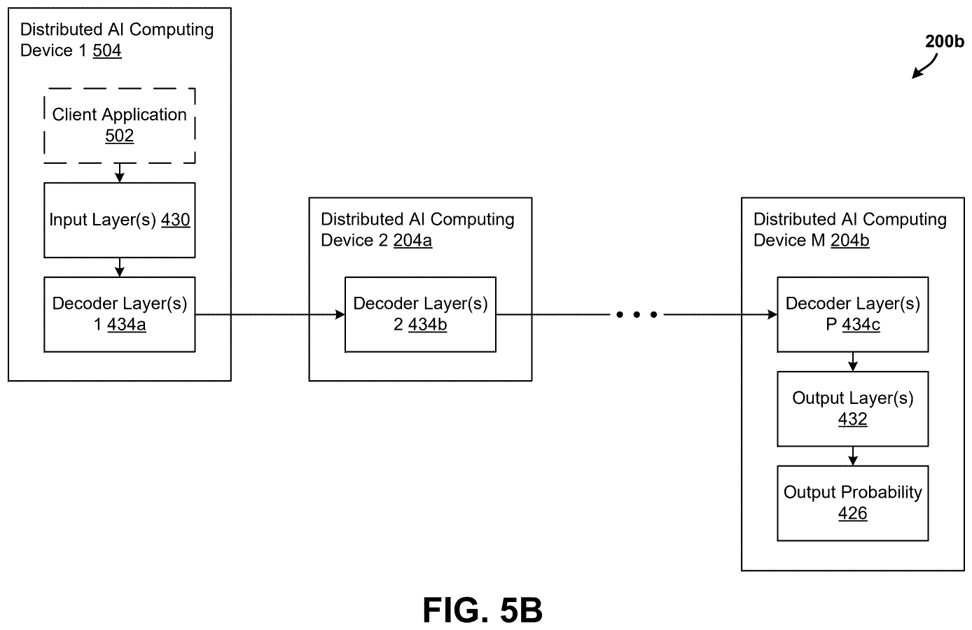

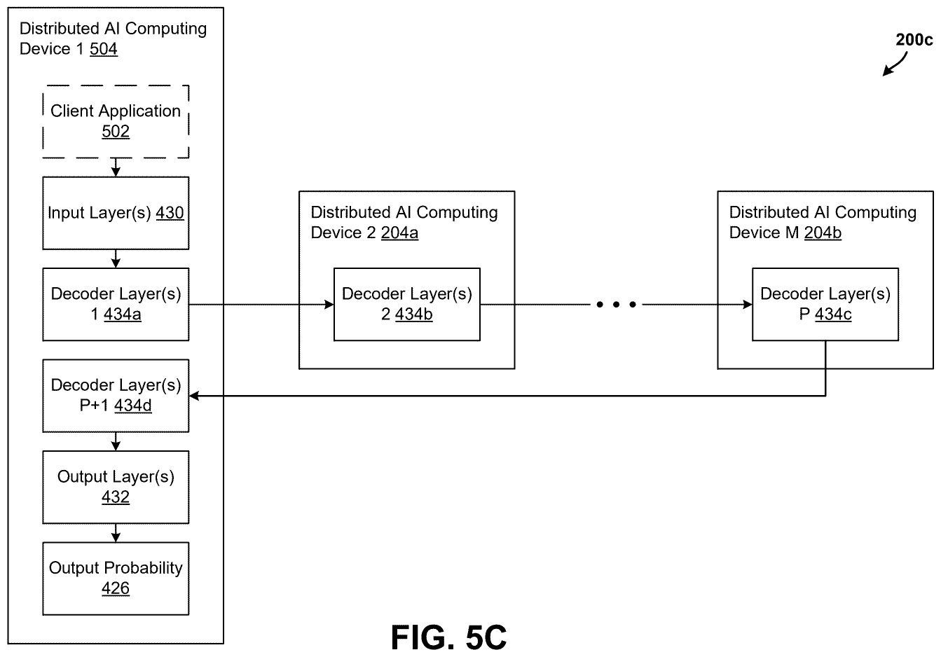

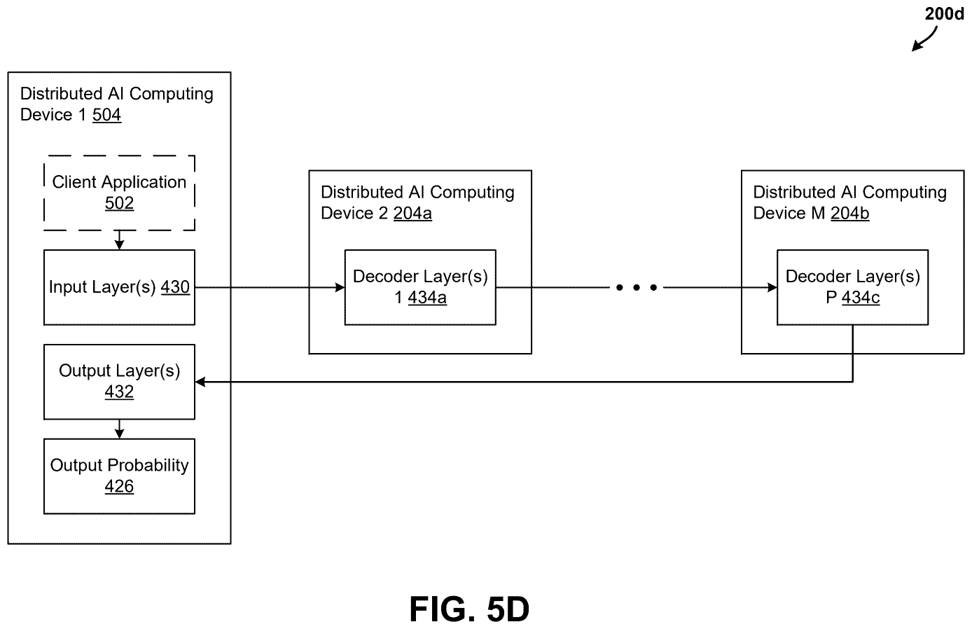

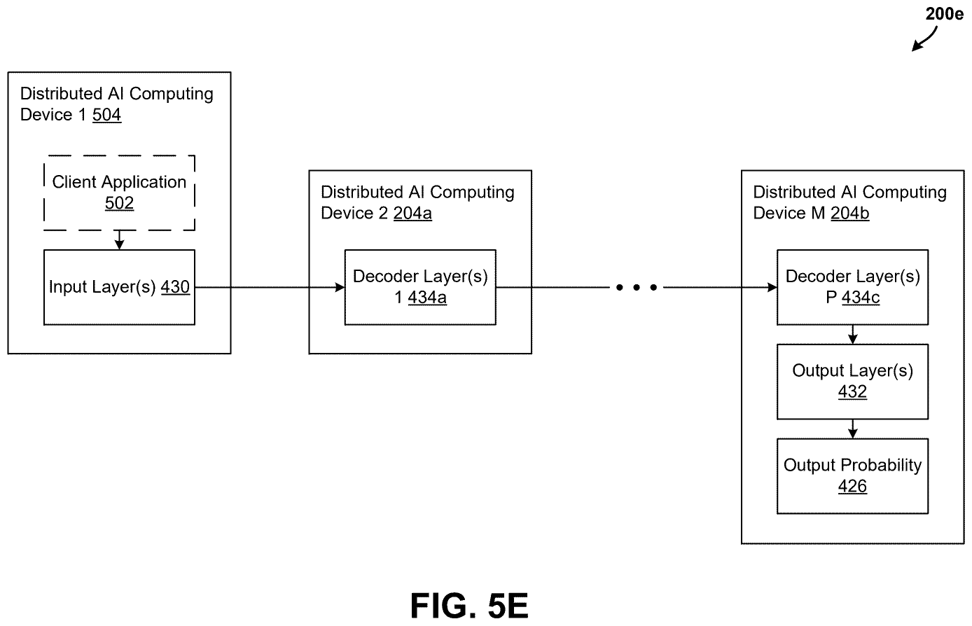

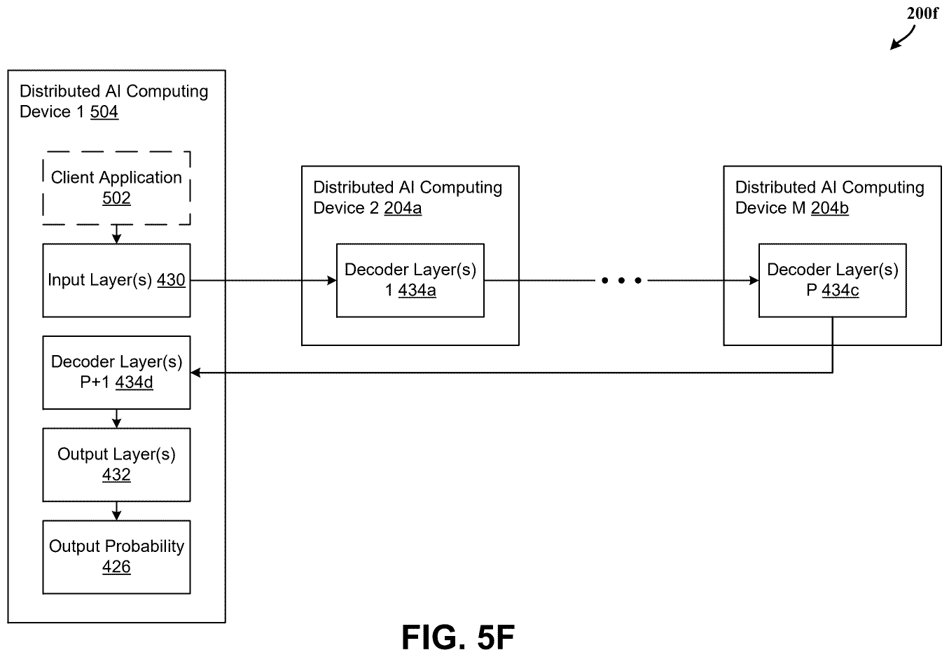

FIG. 5A to FIG. 5F are block diagrams illustrating examples of an LXM distribution across computing devices 204a, 204b, 504 (e.g., computing devices 202, 204 in FIG. 3A to FIG. 3B) of a distributed AI computing system 200a, 200b, 200c, 200d, 200e, 200f (e.g., distributed AI computing system 200 in FIG. 3A to FIG. 3B) in accordance with some aspects. With reference to FIG. 2 to FIG. 5F, the computing devices 204a, 204b, 504 may be configured to implement various parts of the distributed LXM (e.g., LXM 400 in FIG. 4), including the input layers 430, the decoder layers 434a, 434b, 434c (e.g., decoder layers 410, 412, 414, 416, 434 in FIG. 4), and/or output layers 432. Each of the computing devices 202, 204a, 204b, 504, etc. may include one or more processing systems including one or more processors coupled to at least one memory (e.g., processing system 302, 322 in FIG. 2, FIG. 3A, and FIG. 3B) configured to implement the parts of the distributed LXM. The processing systems of the initial distributed AI computing device 504 may also be configured to implement a client application 502.

In some aspects, any of the distributed AI computing system 200a, 200b, 200c, 200d, 200e, 200f the initial distributed AI computing device 504 may be optionally configured to implement the client application 502. In some aspects, the client application 502 may be implemented by a distributed AI computing device 204a, 204b or another computing device (not shown) communication connected to the initial distributed AI computing device 504.

With reference to the distributed AI computing systems 200a, the initial distributed AI computing device 504 may be configured to implement an allocated portion of the distributed LXM including any combination of the one or more input layers 430, the one or more decoder layers 434a, and the one or more output layers 432. The distributed AI computing devices 204a, 204b may each be configured to implement allocated portions of the distributed LXM including one or more decoder layers 434b, 434c. The initial distributed AI computing device 504 may be configured to divide an input (e.g., input 402 in FIG. 4) to the distributed LXM into input chunks of the input chunk size.

In response to a prompt from the client application 502, which may also provide the input, the initial distributed AI computing device 504 may implement the distributed LXM by batch processing the input chunks of the input. The initial distributed AI computing device 504 may process a first input chunk by executing an allocated portion of the distributed LXM, the one or more input layers 430 and the one or more decoder layers 434a, generating a first intermediary chunk, and transmitting the first intermediary chunk to the distributed AI computing device 204a.

In parallel with transmitting the first intermediary chunk, the initial distributed AI computing device 504 may process a second input chunk generating a second intermediary chunk. In parallel with the initial distributed AI computing device 504 processing the second input chunk, the distributed AI computing device 204a may process the first intermediary chunk by executing an allocated portion of the distributed LXM, the one or more decoder layers 434b, generating a third intermediary chunk, and transmitting the third intermediary chunk to the distributed AI computing device 204b.

In parallel with transmitting the third intermediary chunk, the initial distributed AI computing device 504 may process a remaining subsequent input chunk, and the distributed AI computing device 204a may process the second intermediary chunk. In parallel with the initial distributed AI computing device 504 processing the remaining subsequent input chunk and the distributed AI computing device 204a processing the second intermediary chunk, the distributed AI computing device 204b may process the third intermediary chunk by executing an allocated portion of the distributed LXM, the one or more decoder layers 434c, generating a fourth intermediary chunk. The distributed AI computing device 204b may transmit the fourth intermediary chunk to the initial distributed AI computing device 504.

In parallel with transmitting the fourth intermediary chunk, the initial distributed AI computing device 504 may process a remaining subsequent input chunk, and the distributed AI computing devices 204a, 204b may process remaining intermediary chunks. In parallel with the initial distributed AI computing device 504 processing the remaining subsequent input chunk, and the distributed AI computing devices 204a, 204b processing remaining intermediary chunks, the initial distributed AI computing device 504 may process the fourth intermediary chunk by executing the one or more output layers 432, generating an output probability 426, or output chunk.

With reference to the distributed AI computing system 200b, the initial distributed AI computing device 504 may be configured to implement the allocated portion of the distributed LXM including the one or more input layers 430 and the one or more decoder layers 434a. The distributed AI computing device 204a may be configured to implement an allocated portion of the distributed LXM including one or more decoder layers 434b. The distributed AI computing device 204c may be configured to implement an allocated portions of the distributed LXM including one or more decoder layers 434c and the one or more output layers 432. The initial distributed AI computing device 504 may be configured to divide an input (e.g., input 402 in FIG. 4) to the distributed LXM into input chunks of the input chunk size.

The initial distributed AI computing device 504 implementing the allocated portion of the distributed LXM, the one or more input layers 430 and the one or more decoder layers 434a, may be implemented as described with reference to the distributed AI computing system 200a. Similarly, the distributed AI computing device 204a implementing the allocated portion of the distributed LXM, the one or more decoder layers 434b, may be implemented as described with reference to the distributed AI computing system 200a.

In parallel with the initial distributed AI computing device 504 processing a remaining subsequent input chunk and the distributed AI computing device 204a processing a second intermediary chunk, the distributed AI computing device 204c may process the third intermediary chunk by executing an allocated portion of the distributed LXM, the one or more decoder layers 434c, generating a fourth intermediary chunk.

In parallel with the initial distributed AI computing device 504 processing a remaining subsequent input chunk, and the distributed AI computing devices 204a, 204c processing remaining intermediary chunks, the distributed AI computing device 204c may process the fourth intermediary chunk by executing the one or more output layers 432, generating an output probability 426, or output chunk.

With reference to the distributed AI computing system 200c, the initial distributed AI computing device 504 may be configured to implement the allocated portion of the distributed LXM including the one or more input layers 430, the one or more decoder layers 434a, 434d, and the one or more output layers 432. The distributed AI computing device 204a may be configured to implement an allocated portion of the distributed LXM including one or more decoder layers 434b. The distributed AI computing device 204c may be configured to implement an allocated portion of the distributed LXM including one or more decoder layers 434c. The initial distributed AI computing device 504 may be configured to divide an input (e.g., input 402 in FIG. 4) to the distributed LXM into input chunks of the input chunk size.

The initial distributed AI computing device 504 implementing the allocated portion of the distributed LXM, the one or more input layers 430 and the one or more decoder layers 434a, may be implemented as described with reference to the distributed AI computing system 200a. Similarly, the distributed AI computing devices 204a, 204b implementing the allocated portion of the distributed LXM, the one or more decoder layers 434b, 434c, may be implemented as described with reference to the distributed AI computing system 200a.

In parallel with the distributed AI computing devices 204b transmitting the fourth intermediary chunk, the initial distributed AI computing device 504 may process remaining subsequent input chunks, and the distributed AI computing devices 204a, 204b may process remaining intermediary chunks. In parallel with the initial distributed AI computing device 504 processing the remaining subsequent input chunks, and the distributed AI computing devices 204a, 204b processing remaining intermediary chunks, the initial distributed AI computing device 504 may process the fourth intermediary chunk by executing an allocated portion of the distributed LXM, the one or more decoder layers 434d, generating a fifth intermediary chunk. In parallel with the initial distributed AI computing device 504 processing remaining subsequent input chunks and remaining intermediary chunks, and the distributed AI computing devices 204a, 204b processing remaining intermediary chunks, the initial distributed AI computing device 504 may process the fifth intermediary chunk by executing the one or more output layers 432, generating an output probability 426, or output chunk.

With reference to the distributed AI computing system 200d, the initial distributed AI computing device 504 may be configured to implement an allocated portion of the distributed LXM including the one or more input layers 430 and the one or more output layers 432. The distributed AI computing devices 204a, 204b may each be configured to implement allocated portions of the distributed LXM including one or more decoder layers 434b, 434c. The initial distributed AI computing device 504 may be configured to divide an input (e.g., input 402 in FIG. 4) to the distributed LXM into input chunks of the input chunk size.

In response to a prompt from the client application 502, which may also provide the input, the initial distributed AI computing device 504 may implement the distributed LXM by batch processing the input chunks of the input. The initial distributed AI computing device 504 may process a first input chunk by executing the one or more input layers 430 generating a first intermediary chunk and transmitting the first intermediary chunk to the distributed AI computing device 204a.

In parallel with transmitting the first intermediary chunk, the initial distributed AI computing device 504 may process a second input chunk generating a second intermediary chunk. In parallel with the initial distributed AI computing device 504 processing the second input chunk, the distributed AI computing device 204a may process the first intermediary chunk by executing an allocated portion of the distributed LXM, the one or more decoder layers 434b, generating a third intermediary chunk, and transmitting the third intermediary chunk to the distributed AI computing device 204b.

In parallel with transmitting the third intermediary chunk, the initial distributed AI computing device 504 may process a remaining subsequent input chunk, and the distributed AI computing device 204a may process the second intermediary chunk. In parallel with the initial distributed AI computing device 504 processing the remaining subsequent input chunk and the distributed AI computing device 204a processing the second intermediary chunk, the distributed AI computing device 204b may process the third intermediary chunk by executing an allocated portion of the distributed LXM, the one or more decoder layers 434c, generating a fourth intermediary chunk. The distributed AI computing device 204b may transmit the fourth intermediary chunk to the initial distributed AI computing device 504.

In parallel with transmitting the fourth intermediary chunk, the initial distributed AI computing device 504 may process a remaining subsequent input chunk, and the distributed AI computing devices 204a, 204b may process remaining intermediary chunks. In parallel with the initial distributed AI computing device 504 processing the remaining subsequent input chunk, and the distributed AI computing devices 204a, 204b processing remaining intermediary chunks, the initial distributed AI computing device 504 may process the fourth intermediary chunk by executing the one or more output layers 432, generating an output probability 426, or output chunk.

With reference to the distributed AI computing system 200e, the initial distributed AI computing device 504 may be configured to implement an allocated portion of the distributed LXM including the one or more input layers 430. The distributed AI computing device 204a may be configured to implement an allocated portion of the distributed LXM including one or more decoder layers 434b. The distributed AI computing device 204c may be configured to implement an allocated portions of the distributed LXM including one or more decoder layers 434c and the one or more output layers 432. The initial distributed AI computing device 504 may be configured to divide an input (e.g., input 402 in FIG. 4) to the distributed LXM into input chunks of the input chunk size.

The initial distributed AI computing device 504 implementing the one or more input layers 430 may be implemented as described with reference to the distributed AI computing system 200d. Similarly, the distributed AI computing device 204a implementing the allocated portion of the distributed LXM, the one or more decoder layers 434b, may be implemented as described with reference to the distributed AI computing system 200d.

In parallel with the initial distributed AI computing device 504 processing a remaining subsequent input chunk and the distributed AI computing device 204a processing a second intermediary chunk, the distributed AI computing device 204c may process the third intermediary chunk by executing an allocated portion of the distributed LXM, the one or more decoder layers 434c, generating a fourth intermediary chunk.

In parallel with the initial distributed AI computing device 504 processing a remaining subsequent input chunk, and the distributed AI computing devices 204a, 204c processing remaining intermediary chunks, the distributed AI computing device 204c may process the fourth intermediary chunk by executing the one or more output layers 432, generating an output probability 426, or output chunk.

With reference to the distributed AI computing system 200f, the initial distributed AI computing device 504 may be configured to implement the allocated portion of the distributed LXM including the one or more input layers 430, the one or more decoder layers 434d, and the one or more output layers 432. The distributed AI computing device 204a may be configured to implement an allocated portion of the distributed LXM including one or more decoder layers 434b. The distributed AI computing device 204c may be configured to implement an allocated portion of the distributed LXM including one or more decoder layers 434c. The initial distributed AI computing device 504 may be configured to divide an input (e.g., input 402 in FIG. 4) to the distributed LXM into input chunks of the input chunk size.

The initial distributed AI computing device 504 implementing the one or more input layers 430 may be implemented as described with reference to the distributed AI computing system 200d. Similarly, the distributed AI computing devices 204a, 204b implementing the allocated portion of the distributed LXM, the one or more decoder layers 434b, 434c, may be implemented as described with reference to the distributed AI computing system 200d.

In parallel with the distributed AI computing devices 204b transmitting the fourth intermediary chunk, the initial distributed AI computing device 504 may process remaining subsequent input chunks, and the distributed AI computing devices 204a, 204b may process remaining intermediary chunks. In parallel with the initial distributed AI computing device 504 processing the remaining subsequent input chunks, and the distributed AI computing devices 204a, 204b processing remaining intermediary chunks, the initial distributed AI computing device 504 may process the fourth intermediary chunk by executing an allocated portion of the distributed LXM, the one or more decoder layers 434d, generating a fifth intermediary chunk. In parallel with the initial distributed AI computing device 504 processing remaining subsequent input chunks and remaining intermediary chunks, and the distributed AI computing devices 204a, 204b processing remaining intermediary chunks, the initial distributed AI computing device 504 may process the fifth intermediary chunk by executing the one or more output layers 432, generating an output probability 426, or output chunk.

In the foregoing examples, existing remaining input chunks and remaining intermediary chunks may be processed. The foregoing examples may be similarly implemented without implementing processing for nonexistent remaining input chunks.

In any or all of the foregoing examples, a first device (e.g., initial distributed AI computing device 504) may run the input embedding layer and the output linear layer. Alternatively, the input embedding layer and the output linear layer may run on last device (e.g., distributed AI computing device 204b).

When speculative decoding (SPD) is enabled, the first device (e.g., initial distributed AI computing device 504) may additionally run the draft model. When self-speculative decoding (SSD) is enabled, the first device (e.g., initial distributed AI computing device 504) may generate speculative (lookahead) tokens.

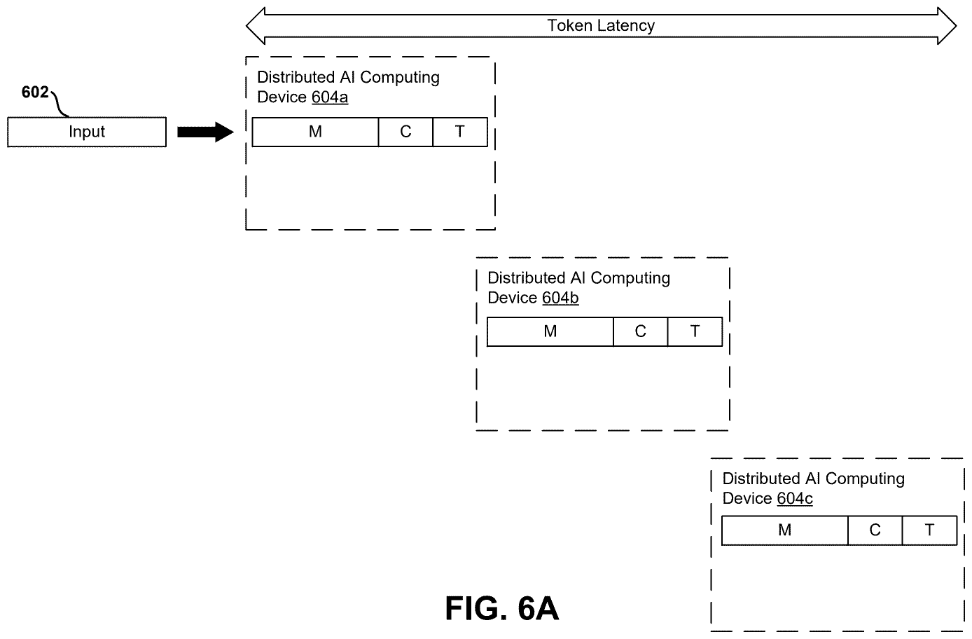

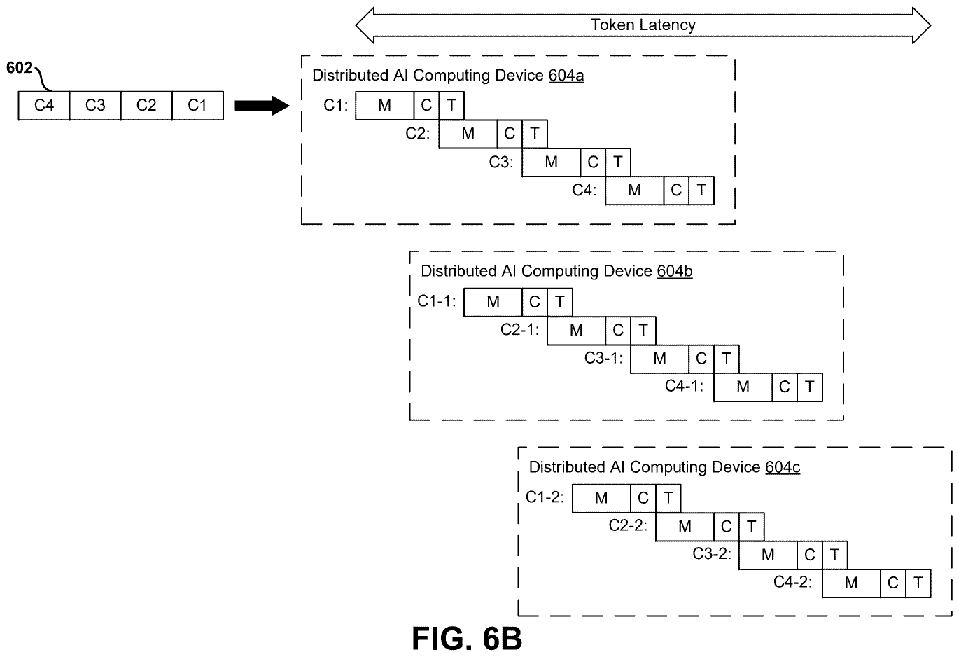

FIG. 6A is a block diagram illustrating LXM input processing in an LXM distribution across computing devices 604a, 604b, 604c (e.g., computing devices 202, 204, 204a, 204b, 504 in FIG. 3A to FIG. 3B, and FIG. 5A to FIG. 5F) of a distributed AI computing system (e.g., distributed AI computing system 200, 200a, 200b, 200c, 200d, 200e, 200f in FIG. 3A to FIG. 3B, and FIG. 5A to FIG. 5F) in accordance with some aspects. With reference to FIG. 2 to FIG. 6B, an input 602 (e.g., input 402 in FIG. 4) may be input in batches to a distributed LXM (e.g., LXM 400 in FIG. 4) distributed across the computing devices 604a, 604b, 604c, and processed, generating intermediary chunks. Processing of the input and the intermediary chunks may take time, including a memory I/O latency time (M), a compute time (C), and a time for transmission between computing devices 604a, 604b, 604c (T).

The input may be processed by the distributed AI computing device 604a implementing an allocated portion of the distributed LXM including one or more input layers (e.g., embedding layer 404, positional encoding layer 406, input layer 430 in FIG. 5A to FIG. 5F) and/or one or more decoder layers (e.g., decoder layers 410, 412, 414, 416, 434, 434a, 434b, 434c, 434d in FIG. 5A to FIG. 5F). Processing the input 602 may generate intermediary chunks. The memory and compute operations for processing the input may be implemented serially. The transmission operations for transmitting the intermediary chunks may occur serially with the memory and/or compute operations for processing the input.

The intermediary chunks may be processed by a distributed AI computing device 604b implementing an allocated portion of the distributed LXM including one or more decoder layers. Processing the intermediary chunks may generate further intermediary chunks. The memory and compute operations for processing the intermediary chunks may be implemented serially. The transmission operations for transmitting the intermediary chunks may occur serially with the memory and/or compute operations for processing the intermediary chunks. Memory, compute, and transmission operations implemented by the distributed AI computing device 604b may be implemented serially with memory, compute, and transmission operations implemented by the distributed AI computing device 604a.

The intermediary chunks may be processed by a distributed AI computing device 604c implementing an allocated portion of the distributed LXM including one or more decoder layers. Processing the intermediary chunks may generate further intermediary chunks (not shown). The memory and compute operations for processing the intermediary chunks may be implemented serially. The transmission operations for transmitting the further intermediary chunks may occur serially with the memory and/or compute operations for processing the intermediary chunks. Memory, compute, and transmission operations implemented by the distributed AI computing device 604c may be implemented serially with memory, compute, and transmission operations implemented by the distributed AI computing device 604b.

FIG. 6B is a block diagram illustrating LXM input chunking and chunk parallel processing in an LXM distribution across computing devices 604a, 604b, 604c (e.g., computing devices 202, 204, 204a, 204b, 504 in FIG. 3A to FIG. 3B, and FIG. 5A to FIG. 5F) of a distributed AI computing system (e.g., distributed AI computing system 200, 200a, 200b, 200c, 200d, 200e, 200f in FIG. 3A to FIG. 3B, and FIG. 5A to FIG. 5F) in accordance with some aspects. With reference to FIG. 2 to FIG. 6B, an input 602 (e.g., input 402 in FIG. 4) may be divided into input chunks (e.g., C1, C2, C3, C4) of an input chunk size. The input chunks may be input in batches to a distributed LXM (e.g., LXM 400 in FIG. 4) distributed across the computing devices 604a, 604b, 604c, and processed, generating intermediary chunks (e.g., C1-1, C2-1, C3-1, C4-1, C1-2, C2-2, C3-2, C4-2). Processing of input and intermediary chunks may take time, including a memory I/O latency time (M), a compute time (C), and a time for transmission between computing devices 604a, 604b, 604c (T).

The input chunks may be processed by the distributed AI computing device 604a implementing an allocated portion of the distributed LXM including one or more input layers (e.g., embedding layer 404, positional encoding layer 406, input layer 430 in FIG. 5A to FIG. 5F) and/or one or more decoder layers (e.g., decoder layers 410, 412, 414, 416, 434, 434a, 434b, 434c, 434d in FIG. 5A to FIG. 5F). Processing the input chunks may generate intermediary chunks (e.g., C1-1, C2-1, C3-1, C4-1). The memory and compute operations for processing the input chunks may be implemented serially. The transmission operations for transmitting the intermediary chunks may occur in parallel with the memory and/or compute operations for processing the input chunks.

The intermediary chunks (e.g., C1-1, C2-1, C3-1, C4-1) may be processed by a distributed AI computing device 604b implementing an allocated portion of the distributed LXM including one or more decoder layers. Processing the intermediary chunks (e.g., C1-1, C2-1, C3-1, C4-1) may generate further intermediary chunks (e.g., C1-2, C2-2, C3-2, C4-2). The memory and compute operations for processing the intermediary chunks (e.g., C1-1, C2-1, C3-1, C4-1) may be implemented serially. The transmission operations for transmitting the intermediary chunks (e.g., C1-2, C2-2, C3-2, C4-2) may occur in parallel with the memory and/or compute operations for processing the intermediary chunks (e.g., C1-1, C2-1, C3-1, C4-1). Memory, compute, and transmission operations implemented by the distributed AI computing device 604b may be implemented in parallel with memory, compute, and transmission operations implemented by the distributed AI computing device 604a.

The intermediary chunks (e.g., C1-2, C2-2, C3-2, C4-2) may be processed by a distributed AI computing device 604c implementing an allocated portion of the distributed LXM including one or more decoder layers. Processing the intermediary chunks (e.g., C1-2, C2-2, C3-2, C4-2) may generate further intermediary chunks (not shown). The memory and compute operations for processing the intermediary chunks (e.g., C1-2, C2-2, C3-2, C4-2) may be implemented serially. The transmission operations for transmitting the further intermediary chunks may occur in parallel with the memory and/or compute operations for processing the intermediary chunks (e.g., C1-2, C2-2, C3-2, C4-2). Memory, compute, and transmission operations implemented by the distributed AI computing device 604c may be implemented in parallel with memory, compute, and transmission operations implemented by the distributed AI computing device 604a and/or the distributed AI computing device 604b.

Chunking of the input may enable parallel execution of the memory, compute, and transmission operations implemented by the computing devices 604a, 604b, 604c for implementing the distributed LXM. Leveraging chunking of the input and parallel execution of the operations for implementing the distributed LXM may reduce the token latency as compared to serial processing of a not chunked input in a non-distributed LXM or distributed LXM, as illustrated in FIG. 6A.

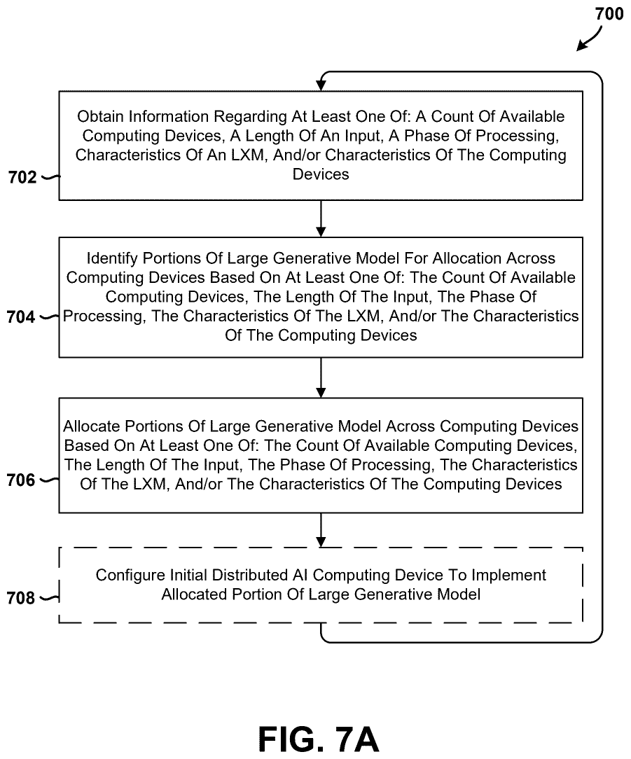

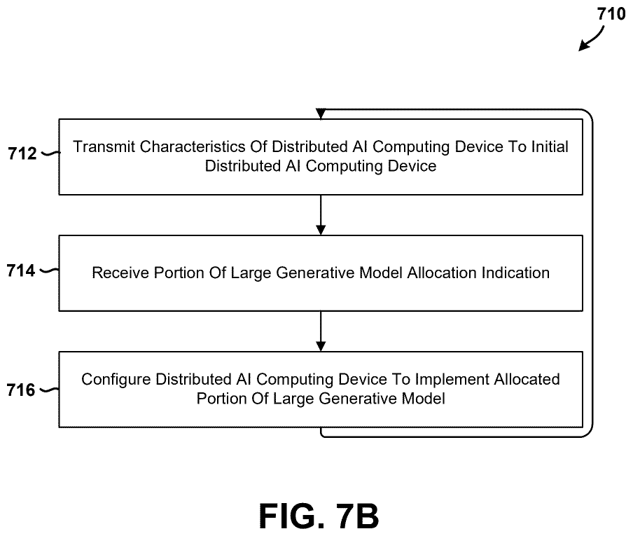

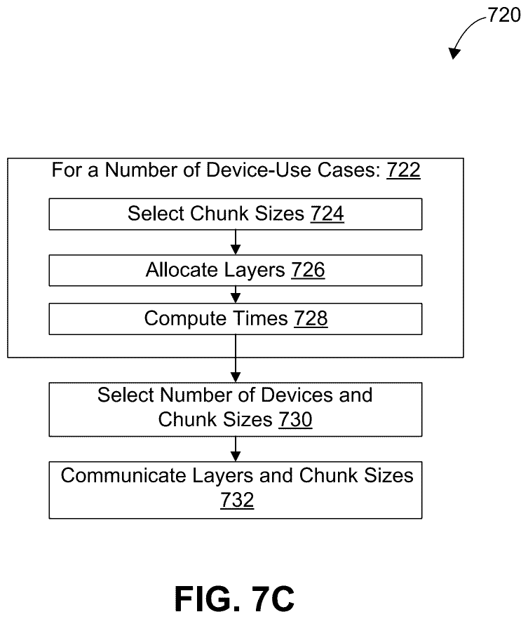

FIG. 7A and FIG. 7B are process flow diagrams illustrating methods 700, 710 for distributing an LXM (e.g., LXM 400 in FIG. 4) across computing devices (e.g., computing devices 202, 204, 204a, 204b, 504, 604a, 604b, 604c in FIG. 3A to FIG. 3B, and FIG. 5A to FIG. 6B) of a distributed AI computing system (e.g., distributed AI computing system 200, 200a, 200b, 200c, 200d, 200e, 200f in FIG. 3A to FIG. 3B, and FIG. 5A to FIG. 6B) in accordance with some aspects. With reference to FIG. 2 to FIG. 7B, the methods 700, 710 may be performed in a computing device by at least one processing system including at least one memory having executable instructions thereon coupled to one or more processors configured to execute the executable instructions (e.g., processing system 302, 322 in FIG. 2, FIG. 3A, and FIG. 3B) and components (e.g., module 308-316 in FIG. 3A and FIG. 3B) or subsystems discussed in this application. Means for performing the functions of the operations in the methods 700, 710 may include a processing system including one or more processors, at least one memory and other components described herein. Further, one or more processors of a processing system may be configured with software or firmware to perform some or all of the operations of the methods 700, 710. In order to encompass the alternative configurations enabled in various aspects, the hardware implementing any or all of the methods 700, 710 is referred to herein as a “processor.”

With reference to the method 700, in block 702, the processor may obtain information indicative of a count of the available computing devices, a length of an input, a phase of processing, characteristics of the LXM, and/or characteristics of the computing devices. There may be a pool of available computing devices (e.g., a pool of distributed AI computing devices 204) to which LXM distribution module 308 may allocate portions of the LXM. Each available of the pool of available computing devices may be available to be used to process data using a portion of the LXM allocated to it. The LXM may be provided with an input prompt. The input prompt may be made up of a number of tokens. For example, the input prompt may be parsed into a number of input tokens (e.g., words, punctuations, portions of words, etc.). The LXM may process data in a prefill stage (e.g., encoding the input prompt to generate an input embedding). Additionally, the LXM may process the input embedding to generate output data (e.g., predicting a next token, based on the input embedding).

Characteristics of computing devices (e.g., computing devices 202, 204, 204a, 204b, 504, 604a, 604b, 604c in FIG. 3A to FIG. 3B, and FIG. 5A to FIG. 6B). In some aspects, the processor receiving or retrieving the characteristics of the computing devices in block 702 may include a processing system (e.g., processing system 302, 322 in FIG. 2, FIG. 3A and FIG. 3B), an LXM distribution module (e.g., LXM distribution module 308 in FIG. 3A and FIG. 3B), or a TX/RX module (e.g., TX/RX module 314 in FIG. 3A and FIG. 3B).

Characteristics of computing devices may include characteristics of one or more distributed AI computing devices, which may include an initial distributed AI computing device. The characteristics may be retrieved from a memory (e.g., electronic storage 306, 326 in FIG. 2, FIG. 3A and FIG. 3B) and/or received from the one or more distributed AI computing devices. The characteristics may include computing device capability and connectivity conditions between computing devices. For example, computing device capability may include available compute capacity, available memory capacity, available memory bandwidth, available power, etc. of each of the computing devices. As another example, connectivity conditions may include available bandwidth, signal strength, signal quality, signal reliability, signal latency, etc. between the computing devices.

In some aspects, the processor may also obtain characteristics of the LXM. The characteristics may be retrieved from the memory. Characteristics of the LXM may include varying sizes, complexities, parameters, and/or tokens. For example, the Characteristics of the LXM may include a number of decoder layers, a model dimension size, a number of parameters, a vocabulary size, a max context length, an attention mechanism (e.g., multi-head attention or group query attention), etc. In some aspects, the processor may also retrieve characteristics of an input to the LXM, such as a token length.

In block 704, the processor may identify portions of the LXM for allocation across the computing devices in which the division is based on at least one of: the count of available computing devices, the length of the input, the phase of processing, the characteristics of the LXM, and/or the characteristics of the computing devices. The portions of the LXM may include at least one input layer (e.g., embedding layer 404, positional encoding layer 406, input layer 430 in FIG. 5A to FIG. 5F), decoder layer (e.g., decoder layer 410, 412, 414, 416, 434, 434a, 434b, 434c, 434d in FIG. 5A to FIG. 5F), or output layers (e.g., linear layers 422, softmax layer 424, output layers 434 in FIG. 5A to FIG. 5F) of the LXM. The processor may identify how many input layers, decoder layers, or output layers each computing device may implement while balancing execution time the LXM, or the input layers, the decoder layers, or the output layers, across the computing device. In some aspects, the processor may identify the portions of the LXM for allocation across the computing devices based on the characteristics of the LXM. In some aspects, the processor identifying the portions of the LXM for allocation across the computing devices based on the capabilities of the computing devices in block 704 may include the processor or the LXM distribution module.

In block 706, the processor may allocate the portions of the LXM across the computing devices based on at least one of: the count of available computing devices, the length of the input, the phase of processing, the characteristics of the LXM, and/or the characteristics of the computing devices. Based on identifying how many input layers, decoder layers, or output layers each computing device may be allocated to implement while balancing execution time the LXM, the processor may identify which input layers, decoder layers, or output layers each computing device may be allocated to implement while maintaining the time balance. The processor may generate and transmit or store an indication of the portion of the LXM allocated to each computing device, which may indicate the input layers, decoder layers, or output layers of the portion. For example, the processor may transmit the indication directly to a software or store the indication to the memory of the initial distributed AI computing device. As another example, the processor may transmit one or more indications to one or more distributed AI computing devices via a wireless communication network (e.g., wireless communication networks 206 in FIG. 3A to FIG. 3B). In some aspects, the processor allocating the portions of the LXM across the computing devices based on the capabilities of the computing devices in block 706 may include the processor, the LXM distribution module, or the TX/RX module.

In optional block 708, the processor may configure the initial distributed AI computing device to implement an allocated portion of the LXM. The processor may be configured to implement the portion of the LXM allocated to the initial distributed AI computing device and not other portions of the distributed LXM. For example, the processor may receive or retrieve the indication of to the portion of the LXM allocated to the initial distributed AI computing device and enable processing of the one or more input layers, decoder layers, or output of the LXM that are included in the portion. Implementation of configuring the initial distributed AI computing device to implement the allocated portion of the LXM in optional block 708 may be based on whether the initial distributed AI computing device is allocated a portion of the LXM. In some aspects, the processor configuring the initial distributed AI computing device to implement the allocated portion of the LXM in optional block 708 may include the processor or an LXM configuration module (e.g., LXM configuration module 312 in FIG. 3A and FIG. 3B).

In some aspects, the processor may continuously, periodically, or episodically implement blocks 702-708. The processor may execute blocks 702-708 during implementation of the LXM across the computing devices. The processor may dynamically redistribute the LXM across the computing devices during the implementation of the LXM.

With reference to the method 710, in block 712, the processor may transmit the characteristics of a distributed AI computing device to the initial distributed AI computing device. In some aspects, the processor transmitting the characteristics of a distributed AI computing device to the organ computing device in block 712 may include a processor (e.g., processing system 302, 322 in FIG. 2, FIG. 3A and FIG. 3B) or a TX/RX module (e.g., TX/RX module 314 in FIG. 3A and FIG. 3B).

In block 714, the processor may receive a portion of the LXM allocation indication. The processor may receive the indication from the initial distributed AI computing device configured to indicate the portion of the LXM the distributed AI computing device may implement, including which one or more input layer (e.g., embedding layer 404, positional encoding layer 406, input layer 430 in FIG. 5A to FIG. 5F), decoder layers (e.g., decoder layer 410, 412, 414, 416, 434, 434a, 434b, 434c, 434d in FIG. 5A to FIG. 5F), or output layers (e.g., linear layers 422, softmax layer 424, output layers 434 in FIG. 5A to FIG. 5F). In some aspects, the processor receiving the portion of the LXM allocation indication in block 714 may include the processing system, the TX/RX module, or an LXM configuration module (e.g., LXM configuration module 312 in FIG. 3A and FIG. 3B).

In block 716, the processor may configure the distributed AI computing device to implement the allocated portion of the LXM. The processor may be configured to implement the portion of the LXM allocated to the distributed AI computing device and not other portions of the distributed LXM. For example, the processor may receive or retrieve the indication of to the portion of the LXM allocated to the distributed AI computing device and enable processing of the one or more input layers, decoder layers, or output layers of the LXM that are included in the portion. In some aspects, the processor configuring the distributed AI computing device to implement the allocated portion of the LXM in block 716 may include the processor or the LXM configuration module.

In some aspects, the processor may continuously, periodically, or episodically implement blocks 712-716. The processor may execute blocks 712-716 during implementation of the LXM across the computing devices. The processor may dynamically redistribute the LXM across the computing devices during the implementation of the LXM.

FIG. 7C is a process flow diagram illustrating an example method 720 for dividing an LXM, according to various aspects of the present disclosure. Method 720 may be implemented at block 704 and block 706 of method 700. For example, block 722, block 724, block 726, block 728, and block 730 may be implemented at block 704 and block 732 may be implemented at block 706.

The end-to-end (“e2e”) performance of a split LXM depends on chunk size for the prefill stage, chunk size or the decode stage, and the number of devices used in the split. The systems and techniques (e.g., LXM distribution module 308) may determine the chunk size for the prefill stage, chunk size or the decode stage, and the number of devices used in the split to decrease or minimize the e2e performance of a split LXM.

One of the factors impacting the split LXM performance is the time it takes to process and generate tokens. This can be expressed by:

$${t}_{e 2 e} = {t}_{ttft} + {t}_{decode}$$

where tₑ₂ₑ represent the time it takes to process an input prompt and generate an LXM output (e.g., e2e processing time);
where t_{ttft} represents the time it takes to process the input prompt and generate first token; and
where t_{decode} represents the time it takes to generate an output.

The time it takes to process the input prompt and generate first token (“t_{ttft}”) may be determined according to a function “f”:

$${t}_{ttft} = f ( D , B , P , t )$$

where D represents a number of devices used in the split LXM;
where B represents the number of chunks;
where P represents the processing time for a single chunk; and
where t represents a transmit latency from one node to another.

B may be determined based on the ceiling of the input prompt length L divided by the chunk size K (e.g., ceil (prompt length/chunk size)). P may be determined based on a time for memory operations (“M(N)”) and a time for compute operations (“C(N, chunk size)”) for the model; where N represents the total number of decoder layers in the LLM. For example,

$$P = M ( N ) + C ( N , chunk size ) .$$

The time it takes to generate an output (“t_{decode}”) time may be determined according to a function “f”:

$${t}_{decode} = f ( output length , D , B , P , t , A )$$

where A represents a token acceptance rate for SSD and/or SPD.

In cases in which SSD and SPD are not enabled, A may be 1.

For the prefill stage, L may represent an input prompt length. For the decode stage, L may be 1; alternatively, in cases in which Speculative Decoding (SPD) or Self SPD (SSD) are used, L may be the draft size. The term “draft size” may refer to the number of speculative tokens that are generated in a single processing loop.

If L<K, the input may be padded to the length of K If L>K, multiple autoregressive rounds are needed to generate the next token.

M(N) may be dominated by model weights & KV$ and device memory BW (GB/s). Buffer for K tokens may be negligible.

The latency for input embedding and output linear layer are small hence not included in the equation for TL_{single}. Also, draft model processing in SPD mode is not included.

C(N,K) may be dominated by model weights & KV$, size of K and device compute capability (TOPS).

At block 722, a computing device (and/or one or more component thereof) (e.g., LXM distribution module 308 of processing systems 302 of FIG. 3A of initial distributed AI computing device 202 of FIG. 3A) may perform block 724, block 726, and block 728 a number of times, for example, once for each of a number of device-use cases. For example, there may be a pool of NN available computing devices to which portions of an LXM may be allocated. For each of a number of possible device use cases (e.g., using 1 device of the pool of NN devices, using 2 devices of the pool of NN devices, using 3 devices of the pool of NN devices, . . . using NN devices of the pool of NN devices), block 722 may perform each of block 724, block 726, and block 728.

At block 724, the computing device (and/or one or more component thereof) may determine a number of possible chunk sizes for both prefill and decode phases. The computing device (and/or one or more component thereof) may determine the possible chunk sizes based on an input length (e.g., a size of an input to the LXM) and a number of available computing devices (e.g., NN).

For example, the computing device (and/or one or more component thereof) may populate a table of chunk sizes based on input lengths and number of devices used. As an example, table 1 includes an example of a table of chunk sizes based on input lengths and number of devices used.

TABLE 1
Chunk Sizes

| | Number | | | | |
|---|---|---|---|---|---|
| | of | | | | |
| | Devices | 1 | 2 | 3 | 4 |
| Input Length | a1 | a2 | a3 | a4 | a5 |
| 11 | b1 | b2 | b3 | b4 | b5 |
| 12 | c1 | c2 | c3 | c4 | c5 |
| 13 | d1 | d2 | d3 | d4 | d5 |
| 14 | e1 | e2 | e3 | e4 | e5 |
| 15 | f1 | f2 | f3 | f4 | f5 |
| 15 | g1 | g2 | g3 | g4 | g5 |

Table 1 may be populated based on an function (“f”) relating a time to process an input prompt to generate first token (“t_{ttft}”) to a number of devices used (“D”), a number of chunks (“B”), a processing time for a single prefill chunk (“P”), and a transmit latency from one node to another (“t”). For example, the computing device (and/or one or more component thereof) may populate table 1 based on:

$${t}_{ttft} = f ( D , B , P , t )$$

At block 724, the chunk size may be selected based on the input length and the number of devices. In some aspects, the input length may not be known. In such cases, chunk sizes from a column of a table, such as example table 1, may be selected.

At block 726, for each of the number of device use cases, layers of the LXM may be provisionally allocated to devices of the pool of available computing devices. At block 728, times may be computed for processing tokens to generate outputs based on the provisional allocation of layers to devices determined at block 726.

For example, for output prompt processing, the computing device (and/or one or more component thereof) may create tables based on t_{decode}, which may be determined according to:

$${t}_{decode} = f ( output length , D , B , P , t , A )$$

Table 2 is provided as an example of decode rate (DR) stats.

TABLE 2
Decode Rate Stats

| | | Multi- | Multi- | | |
|---|---|---|---|---|---|
| | | Node | Node | Max DR | 15% Single |
| Acceptance | Speculative | Max | Chunk | Number of | DR Number |
| Rate | Tokens | DR | Size | Devices | of Devices |
| a1 | a2 | a3 | a4 | a5 | a6 |

The computing device (and/or one or more component thereof) may determine, based on the tables, if speculative decoding should be enabled or disabled based on the number of devices available for the split. Additionally, the computing device (and/or one or more component thereof) may determine the chunk size based on values in the tables (e.g., values in a column: Multi-Node Chunk Size).

The computing device (and/or one or more component thereof) may determine an operational mode (e.g., whether to operate with, or without, speculative decoding based on the size of draft tokens (e.g., values in a column: Speculative Tokens)). The table also includes the number of devices that should be used in decode phase (e.g., in the column 15% Single DR Number of Devices) and the optimum number of devices that should be used (e.g., in the column Max DR Number of Devices).

Table 3 is provided as an example of decode rate (DR) stats with speculative decoding enabled.

TABLE 3
Decode Rate Stats with speculative decoding enabled.

| | | Multi- | Multi- | | 15% Single |
|---|---|---|---|---|---|
| | | Node | Node | Max DR | DR |
| Acceptance | Speculative | Max | Chunk | Number of | Number of |
| Rate | Tokens | DR | Size | Devices | Devices |
| a1 | a2 | a3 | a4 | a5 | a6 |
| b1 | b2 | b3 | b4 | b5 | b6 |

At block 728, the computing device (and/or one or more component thereof) may determine times (e.g., a e2e time) for each chunk size determined at block 724 and each allocation of layers determined at block 726. For example, the computing device (and/or one or more component thereof) may populate a table such as table 4.

TABLE 4
e2e token latencies

| | | Single | | | | | | | |
|---|---|---|---|---|---|---|---|---|---|
| | | Device | | | | | | | |
| Input | Output | Processing | Number of Devices | | | | | | |
| Length | Length | Time | 2 | 4 | 5 | 8 | 10 | 20 | 40 |
| 256 | 32 | a1 | a2 | a3 | a4 | a5 | a6 | a7 | a8 |
| 256 | 256 | b1 | b2 | b3 | b4 | b5 | b6 | b7 | b8 |
| . . . | | | | | | | | | |
| 512 | 32 | d1 | d2 | d3 | d4 | d5 | d6 | d7 | d8 |
| 512 | 256 | e1 | e2 | e3 | e4 | e5 | e6 | e7 | e8 |
| . . . | | | | | | | | | |

At block 730, the computing device (and/or one or more component thereof) (e.g., LXM distribution module 308) may determine the number of devices to use and the chunk sizes based on values in a table, such as Table 4. For example, the computing device (and/or one or more component thereof) may select a column of number of devices to use based on values token latencies in the column.

In some cases, the input may be incomplete at the time the computing device (and/or one or more component thereof) selects the number of devices to use and/or the chunk sizes. For example, the computing device (and/or one or more component thereof) may determine a number of devices to use to process an input and/or a chunk size for the input as the input is still being received. In such cases, the computing device (and/or one or more component thereof) may determine the number of devices to use and/or the chunk size based on the column of devices to use having lower token latencies than other columns.

For example, it is possible that when the split decision is made the exact prompt size in not known, in which case a table which has optimum chunk sizes is communicated between nodes (or from scheduler/orchestrator/anchor to the node/s). Alternatively, each node can also compute or look up the chunk size based on local cached/available table.

When splitting the LXM across different devices, the number of layers mapped of a specific device can vary depending on the device capabilities. In order to optimize the e2e performance the computing device (and/or one or more component thereof) may map the proportional number of layers to devices with higher compute resources and memory bandwidth.

The algorithm for mapping the number of layers per device may be according to a function “f”:

$${t}_{i} = f ( M ( 1 ) , {mbw}_{i} C ( 1 , 1 ) , {tops}_{i} )$$

where t; represents the time for processing single (1) layer of LXM for each device di;
where M(1) represents the memory operations associated with L;
where C(1,1) represents the compute cycles associated with the 1 and chunk size of 1;
where mbwi represents the memory bandwidth of device i; and
where tops; represents compute capability of device I.

The selected number of devices to use for a split LXM in a prefill phase may be different from selected number of devices to use for a split LXM in a decode phase. The numbers of devices may be different due to differences in prompt and output lengths and/or modes of operation (like SSD or non-SSD as defined in (e.g., as illustrated in the examples of Table 2 and Table 3)).

In order to support different numbers of devices between LXM phases, the non-anchor nodes may share their KV caches corresponding to the layers they implement with anchor (designated devices). Additionally or alternatively, the computing device (and/or one or more component thereof) may use the embedding for the last chunk (from last device) and reproduce the KV cache on the anchor device (as a tradeoff between compute and transfer). Additionally or alternatively, anchor/designated devices may reproduce the KV cache for all chunks based on embedding.

At block 732, the computing device (and/or one or more component thereof) may communicate the layers to use and the chunk sizes to other devices. For example, a first device (e.g., initial distributed AI computing device 504) may determine a split and chunk sizes. The first device may communicate the split and chunk sizes to other devices that may implement layers of the LXM (e.g., distributed AI computing devices 204). The other devices may have all the layers of the LXM stored locally. The other devices may load the allocated layers of the LXM into a working memory so that the other devices may participate in processing an input according to the split LXM.

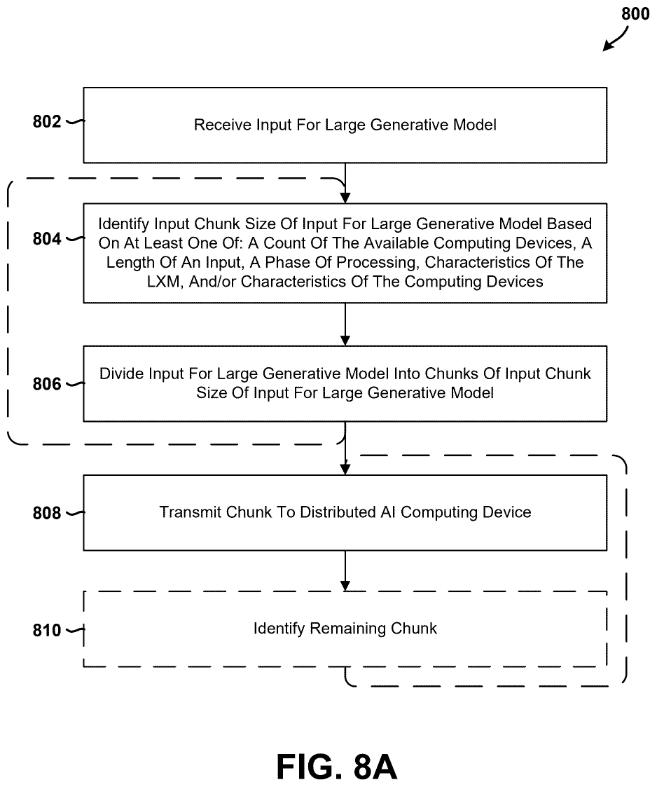

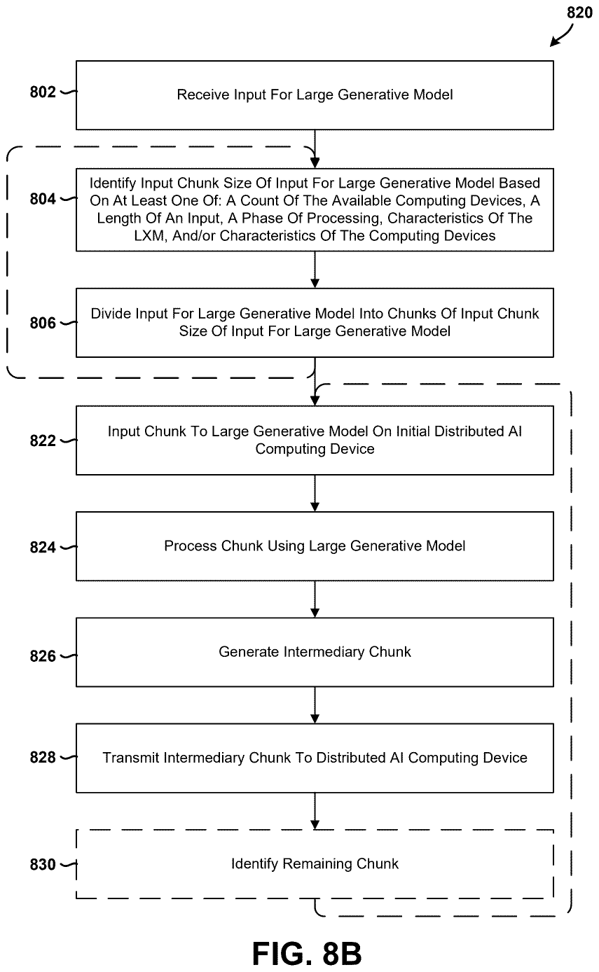

FIG. 8A and FIG. 8B are process flow diagrams illustrating methods 800, 820 for implementing an LXM (e.g., LXM 400 in FIG. 4) distributed across a cluster of computing devices (e.g., computing device 202, 204, 204a, 204b, 504, 604a, 604b, 604c in FIGS. 3A-3B and 5A-6B) of a distributed AI computing system (e.g., distributed AI computing system 200, 200a, 200b, 200c, 200d, 200e, 200f in FIG. 3A-3B, 5A-5F) in accordance with some aspects. With reference to FIG. 2 to FIG. 8B, the methods 800, 820 may be performed in a computing device by at least one processing system including at least one memory having executable instructions thereon coupled to one or more processors configured to execute the executable instructions (e.g., processing system 302, 322 in FIG. 2, FIG. 3A and FIG. 3B and components (e.g., module 308-316 in FIG. 3A and FIG. 3B) or subsystems discussed in this application. Means for performing the functions of the operations in the methods 800, 820 may include a processing system including one or more processors, at least one memory and other components described herein. Further, one or more processors of a processing system may be configured with software or firmware to perform some or all of the operations of the methods 800, 820. In order to encompass the alternative configurations enabled in various aspects, the hardware implementing any or all of the methods 800, 820 is referred to herein as a “processor.”

With reference to the method 800, in block 802, the processor may receive an input token (e.g., input 402, 602 in FIG. 5A to 5F, FIG. 6A, and FIG. 6B) for the LXM. The input token may be for any form of data including data representing text, images, video, sound, etc. In some aspects, the processor receiving the input token for the LXM in block 802 may include a processing system (e.g., processing system 302, 322 in FIG. 2, FIG. 3A and FIG. 3B) or an input chunking module (e.g., input chunking module 310 FIG. 3A and FIG. 3B).

In block 804, the processor may identify an input chunk size of the input token for the LXM based on at least one of: a count of the available computing devices, a length of an input, a phase of processing, characteristics of the LXM, and/or characteristics of the computing devices (e.g., computing devices 202, 204, 204a, 204b, 504, 604a, 604b, 604c in FIG. 3A to FIG. 3B and FIG. 5A to FIG. 6B). In some aspects, the processor receiving the input token for the LXM in block 804 may include the processor or the input chunking module. The input chunk size may be identified based on at least one of: the count of available computing devices, the length of the input, the phase of processing, the characteristics of the LXM, and/or the characteristics of the computing devices.

In some aspects, the processor may identify, such as by estimation or calculation, a metric for implementing the distributed LXM across the computing device. The input chunk size may be identified to achieve various metrics. For example, input chunk size may be identified to achieve reduced token latency. To determine the input chunk size, at block 804, one or more of the operations of method 720 of FIG. 7C may be implemented. For example, block 804 may implement block 722, block 724, block 726, block 728, and/or block 730.

In block 806, the processor may divide the input token for the LXM into input chunks (e.g., C1, C2, C3, C4 in FIG. 6B) of the input chunk size of the input token for the LXM. Based on the identification of the input chunk size, the processor may divide the input token to the LXM into input chunks of the input chunk size. In some aspects, the processor dividing the input token for the LXM into the input chunks of the input chunk size of the input token for the LXM in block 806 may include the processor or the input chunking module.

In some aspects, the input chunking of blocks 804 and 806 may be continuously, periodically, or episodically implemented. The input chunking may be executed during implementation of an LXM across the computing devices. The processor may dynamically reidentify an input chunk size and divide a remaining part of the input token during the implementation of the LXM.

In block 808, the processor may transmit the input chunk to a distributed AI computing device. In some aspects, the processor may transmit the input chunk directed to a specific distributed AI computing device configured to implement a next portion of the distributed LXM or broadcast the input chunk to multiple distributed AI computing devices. Broadcasting the input chunk may enable dynamic redistribution of the LXM across the distributed AI computing devices during execution of the LXM for an input. Broadcasting the input chunk may provide any distributed AI computing device configured to implement a portion of the LXM after execution of the LXM for the input has commenced with the appropriate input chunk for processing. In some aspects, the processor transmitting the input chunk to the distributed AI computing device in block 808 may include the processor or a TX/RX module (e.g., TX/RX module 314 in FIG. 3A and FIG. 3B).

In optional block 810, the processor may identify a remaining input chunk. Remaining input chunks may be input chunks of input tokens that may have yet to be transmitted by on the initial distributed AI computing device. Remaining input chunks may exist stored in a memory, such as a queue. In some aspects, the processor identifying the remaining input chunks in optional block 810 may include the processor, the input chunking module, or the TX/RX module.

The processor may serially transmit input chunks to the distributed AI computing device, repeatedly implementing block 808. The processor may continue to transmit remaining input chunks identified in optional block 810.

With reference to the method 820, blocks 802-806 may be implemented by the processor in a similar manner as described herein for the method 800. In some aspects, the processor implementing blocks 802-806 may include a processing system (e.g., processing system 302, 322 in FIG. 2, FIG. 3A and FIG. 3B) or an input chunking module (e.g., input chunking module 310 in FIG. 3A and FIG. 3B).

In block 822, the processor may input an input chunk to the LXM on the initial distributed AI computing device. The processor may serially input sequential input chunks of the input chunk size to one or more input layers (e.g., embedding layer 404, positional encoding layer 406, input layer 430 in FIG. 5A to FIG. 5F) of the LXM. In some aspects, the processor inputting the input chunk to the LXM on the initial distributed AI computing device in block 822 may include the processor, the input chunking module, or a distributed LXM execution module (e.g., distributed LXM execution module 316 FIG. 3A and FIG. 3B).

In block 824, the processor may process the input chunk using the LXM. Based on a configuration of the initial distributed AI computing device to implement the distributed LXM, implementing the distributed LXM may include implementing the one or more input layers and/or the one or more decoder layers (e.g., decoder layer 410, 412, 414, 416, 434, 434a, 434b, 434c, 434d in FIG. 5A to FIG. 5F) of the portion allocated to the initial distributed AI computing device. For example, based on the indication of the portion of the distributed LXM allocated to the initial distributed AI computing device, the processor may be configured to implement the allocated portion, including the one or more input layers, such as during a prefill phase. Based on the indication of the portion of the distributed LXM allocated to the initial distributed AI computing device, the processor may implement the allocated portion, including one or more decoder layers. In some aspects, the processor processing the input chunk using the LXM in block 824 may include the processor or the distributed LXM execution module.

In block 826, the processor may generate an intermediary chunk (e.g., C1-1, C2-1, C3-1, C4-1, C1-2, C2-2, C3-2, C4-2 in FIG. 6B). Processing the input chunk by execution of the one or more input layers and/or the one or more decoders layers of the portion of the LXM allocated to the initial distributed AI computing device may generate an intermediary chunk. In some aspects, the processor generating the intermediary chunk in block 826 may include the processor or the distributed LXM execution module.

In block 828, the processor may transmit the intermediary chunk to a distributed AI computing device. In some aspects, the processor may transmit the intermediary chunk directed to a specific distributed AI computing device configured to implement a next portion of the distributed LXM or broadcast the intermediary chunk to multiple distributed AI computing devices. Broadcasting the intermediary chunk may enable dynamic redistribution of the LXM across the distributed AI computing devices during execution of the LXM for an input. Broadcasting the intermediary chunk may provide any distributed AI computing device configured to implement a portion of the LXM after execution of the LXM for the input has commenced with the appropriate intermediary chunk for processing. In some aspects, the processor transmitting the intermediary chunk to the distributed AI computing device in block 828 may include the processor or a TX/RX module (e.g., TX/RX module 314 in FIG. 3A and FIG. 3B).

In optional block 830, the processor may identify a remaining input chunk. Remaining input chunks may be input chunks of input tokens that may have yet to be processed on the initial distributed AI computing device. Remaining input chunks may exist stored in a memory, such as a queue. In some aspects, the processor identifying the remaining input chunks in optional block 830 may include the processor the TX/RX module, or the distributed LXM execution module.

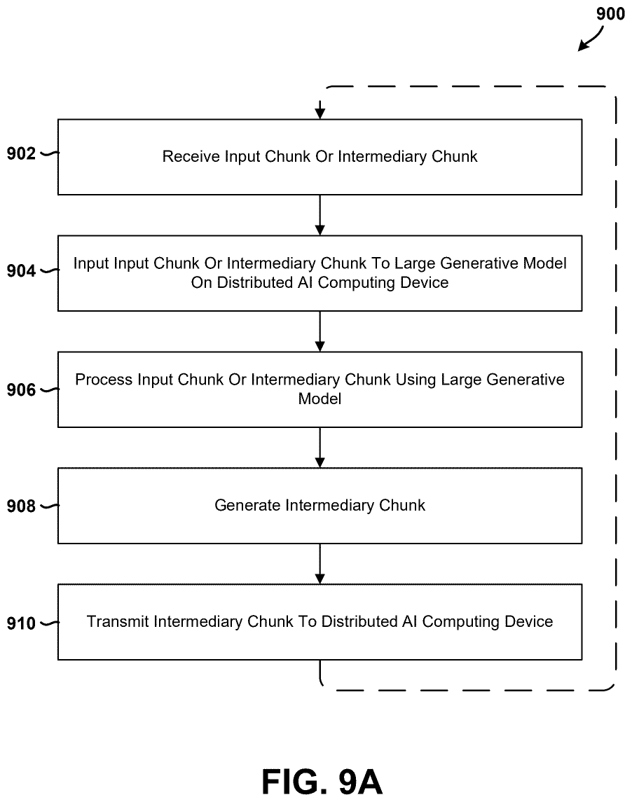

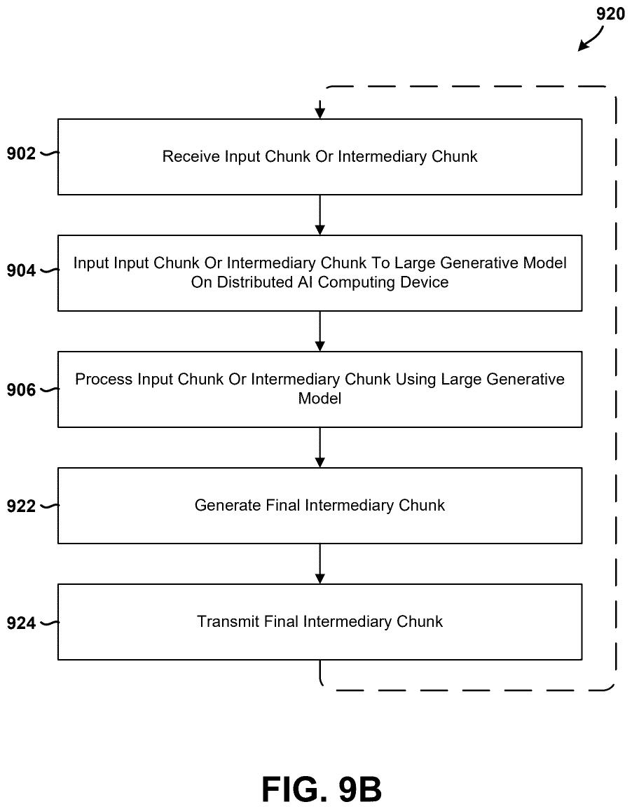

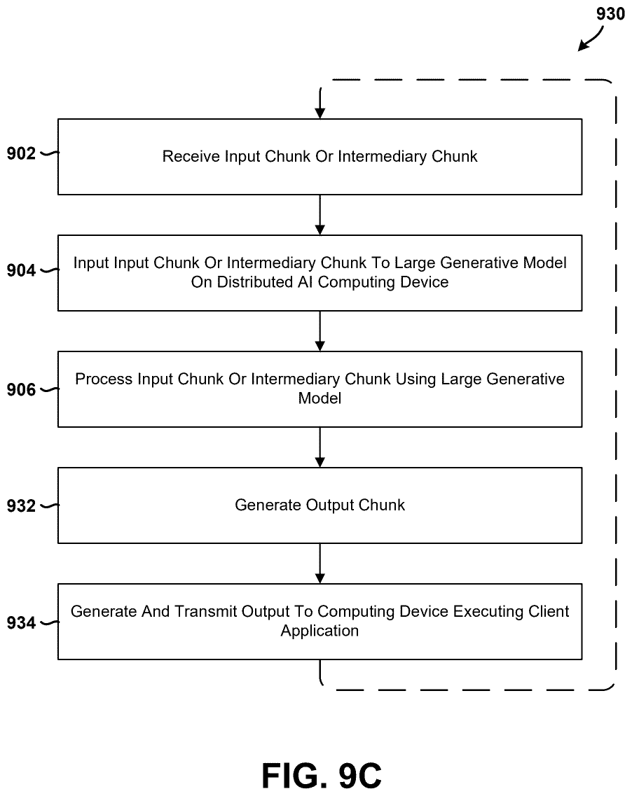

The processor may serially input the input chunks, repeatedly implementing block 822, and serially implement the layers of the LXM that the processor is configured to implement, repeatedly implementing blocks 824 and 826. The processor may also serially transmit generated intermediary chunks to the distributed AI computing device, repeatedly implementing block 828. For example, the processor may implement the one or more input layers and/or the one or more decoder layers for a first input chunk to generate a first intermediary chunk. In parallel with transmitting the first intermediary chunk to the distributed AI computing device, the processor may implement the one or more input layers and/or the one or more decoder layers for a second input chunk to generate a second intermediary chunk. The processor may also implement the one or more input layers and/or the one or more decoder layers for the second input chunk in parallel with one or more distributed AI computing device implementing the distributed LXM for the first intermediary chunk, as described further herein for the methods 900, 920, 930 with reference to FIG. 9A to FIG. 9C. The processor may continue to process subsequent input chunks in parallel with the transmission of previous intermediary chunks.

FIG. 9A to FIG. 9C are process flow diagrams illustrating methods 900, 920, 930 for implementing an LXM (e.g., LXM 400 in FIG. 4) distributed across a cluster of computing devices (e.g., computing device 202, 204, 204a, 204b, 504, 604a, 604b, 604c in FIG. 3A to FIG. 3B and FIG. 5A to FIG. 6B) of a distributed AI computing system (e.g., distributed AI computing system 200, 200a, 200b, 200c, 200d, 200e, 200f in FIG. 3A to FIG. 3B and FIG. 5A to FIG. 6B) in accordance with some aspects. With reference to FIG. 2 to FIG. 9C, the methods 900, 920, 930 may be performed in a computing device by at least one processing system including at least one memory having executable instructions thereon coupled to one or more processors configured to execute the executable instructions (e.g., processing system 302, 322 in FIG. 2, FIG. 3A and FIG. 3B) and components (e.g., module 308-316 in FIG. 3A and FIG. 3B) or subsystems discussed in this application. Means for performing the functions of the operations in the methods 900, 920, 930 may include a processing system including one or more processors, at least one memory, and other components described herein. Further, one or more processors of a processing system may be configured with software or firmware to perform some or all of the operations of the methods 900, 920, 930. In order to encompass the alternative configurations enabled in various aspects, the hardware implementing any or all of the methods 900, 920, 930 is referred to herein as a “processor.”

With reference to the method 900, in block 902, the processor may receive an input chunk (C1, C2, C3, C4 in FIG. 6B) or an intermediary chunk (e.g., C1-1, C2-1, C3-1, C4-1, C1-2, C2-2, C3-2, C4-2 in FIG. 6B). Based on a configuration of the distributed AI computing device to implement the distributed LXM, implementing the distributed LXM may include implementing the one or more input layers (e.g., embedding layer 404, positional encoding layer 406, input layer 430 in FIG. 5A to FIG. 5F) and/or the one or more decoder layers (e.g., decoder layer 410, 412, 414, 416, 434, 434a, 434b, 434c, 434d in FIG. 5A to FIG. 5F) of the portion allocated to the distributed AI computing device. The processor of a distributed AI computing device configured for implementing the one or more input layers and/or one or more decoder layers may receive an input chunk transmitted from an initial distributed AI computing device. The processor of the distributed AI computing device configured for implementing the one or more decoder layers may receive an intermediary chunk transmitted from an initial distributed AI computing device or a different distributed AI computing device depending on the position in the LXM of the portion of the LXM allocated to the distributed AI computing device. In some aspects, the processor receiving the input chunk or the intermediary chunk in block 902 may include a processing system (e.g., processing system 302, 322 in FIG. 2, FIG. 3A to FIG. 3B, and FIG. 5A to FIG. 6B) or a TX/RX module (e.g., TX/RX module 314 in FIG. 3A and FIG. 3B).

In block 904, the processor may input the input chunk or intermediary chunk to LXM on the distributed AI computing device. The processor may serially input the input chunks into the one or more input layers of the portion of the LXM allocated to the distributed AI computing device. The processor may serially input intermediary chunks to the one or more decoder layers of the portion of the LXM allocated to the distributed AI computing device. In some aspects, the processor inputting the input chunk or the intermediary chunk to the LXM on the distributed AI computing device in block 904 may include the processor or a distributed LXM execution module (e.g., distributed LXM execution module 316 in FIG. 3A and FIG. 3B).

In block 906, the processor may process the input chunk or the intermediary chunk using the LXM. Based on a configuration of the distributed AI computing device to implement the distributed LXM, implementing the distributed LXM may include implementing the one or more input layers of the LXM and/or the one or more decoder layers of the portion allocated to the distributed AI computing device. Based on the indication of the portion of the distributed LXM allocated to the distributed AI computing device, the processor may implement the allocated portion, including one or more decoder layers. In some aspects, the processor processing the input chunk or the intermediary chunk using the LXM in block 906 may include the processor or the distributed LXM execution module.

In block 908, the processor may generate an intermediary chunk (e.g., C1-2, C2-2, C3-2, C4-2 in 6). Processing the input chunk or the intermediary chunk by execution of the one or more input layers of the LXM and/or the one or more decoders layers of the portion of the LXM allocated to the distributed AI computing device may generate a next intermediary chunk. In some aspects, the processor generating the intermediary chunk in block 908 may include the processor or the distributed LXM execution module.

In block 910, the processor may transmit the intermediary chunk to a distributed AI computing device. In some aspects, the processor may transmit the next intermediary chunk directed to a specific distributed AI computing device configured to implement a next portion of the distributed LXM or broadcast the next intermediary chunk to multiple distributed AI computing devices. Again, broadcasting the next intermediary chunk may enable dynamic redistribution of the LXM across the distributed AI computing devices during execution of the LXM for an input. Broadcasting the next intermediary chunk may provide any distributed AI computing device configured to implement a portion of the LXM after execution of the LXM for the input has commenced with the appropriate intermediary chunk for processing. In some aspects, the processor transmitting the intermediary chunk to the distributed AI computing device in block 910 may include the processor or the TX/RX module.

The processor may serially receive and input the input chunks or the intermediary chunks, repeatedly implementing blocks 902 and 904, and serially implement the layers of the LXM that the processor is configured to implement, repeatedly implementing blocks 906 and 908. The processor may also serially transmit generated intermediary chunks to the distributed AI computing device, repeatedly implementing block 910. For example, the processor may implement the one or more decoder layers for a first intermediary chunk to generate a second intermediary chunk. In parallel with transmitting the second intermediary chunk to the distributed AI computing device, the processor may implement the one or more decoder layers for a third intermediary chunk to generate a fourth intermediary chunk. The processor may also implement the one or more decoder layers for the first intermediary chunk in parallel with the initial distributed AI computing device or the one or more distributed AI computing device implementing the distributed LXM for generating the third intermediary chunk, as described further herein for the methods 820, 900 with reference to FIG. 8B and FIG. 9A. The processor may also implement the one or more decoder layers for the fourth intermediary chunk in parallel with one or more distributed AI computing device implementing the distributed LXM for the second intermediary chunk, as described further herein for the methods 920, 930 with reference to FIG. 9B and FIG. 9C. The processor may continue to process subsequent intermediary chunks in parallel with the transmission of previous intermediary chunks.

With reference to the method 920, blocks 902-906 may be implemented by the processor in a similar manner as described herein for the method 900. In some aspects, the processor implementing blocks 902-906 may include a processing system (e.g., processing system 302, 322 in FIG. 2, FIG. 3A and FIG. 3B), a TX/RX module (e.g., TX/RX module 314 in FIG. 3A and FIG. 3B), or a distributed LXM execution module (e.g., distributed LXM execution module 316 in FIG. 3A and FIG. 3B).

In block 922, the processor may generate a final intermediary chunk (e.g., C1-1, C2-1, C3-1, C4-1, C1-2, C2-2, C3-2, C4-2 in FIG. 6B). A final intermediary chunk may be like any other intermediary chunk but generated by a final portion of the LXM, having one or more decoder layers (e.g., decoder layer 410, 412, 414, 416, 434, 434a, 434b, 434c, 434d in FIG. 5A to FIG. 5F), positioned in the LXM immediately preceding the one or more output layers (e.g., linear layers 422, softmax layer 424, output layers 434 in FIG. 5A to FIG. 5F). Processing the intermediary chunk by execution of the one or more decoders layers of the portion of the LXM allocated to the distributed AI computing device may generate the final intermediary chunk. In some aspects, the processor generating the final intermediary chunk in block 922 may include the processor or the distributed LXM execution module.

In block 924, the processor may transmit the final intermediary chunk. In some aspects, the processor may transmit the final intermediary chunk directed to the initial distributed AI computing device or another distributed AI computing device configured to implement output layers of the distributed LXM or broadcast the final intermediary chunk to multiple computing devices. Again, broadcasting the final intermediary chunk may enable dynamic redistribution of the LXM across the distributed AI computing devices during execution of the LXM for an input. Broadcasting the final intermediary chunk may provide any distributed AI computing device configured to implement a portion of the LXM after execution of the LXM for the input has commenced with the appropriate intermediary chunk for processing. In some aspects, the processor transmitting the final intermediary chunk in block 924 may include the processor or the TX/RX module.

The processor may serially receive and input the intermediary chunks, repeatedly implementing blocks 902 and 904, and serially implement the layers of the LXM that the processor is configured to implement, repeatedly implementing blocks 906 and 922. The processor may also serially transmit generated final intermediary chunks to the initial distributed AI computing device or another distributed AI computing device, repeatedly implementing block 924. For example, the processor may implement the one or more decoder layers for a first intermediary chunk to generate a first final intermediary chunk. In parallel with transmitting the first final intermediary chunk to the initial distributed AI computing device or another distributed AI computing device, the processor may implement the one or more decoder layers for a second intermediary chunk to generate a second final intermediary chunk. The processor may also implement the one or more decoder layers for the first intermediary chunk in parallel with the initial distributed AI computing device or one or more distributed AI computing devices implementing the distributed LXM for generating the second intermediary chunk, as described further herein for the methods 820, 900 with reference to FIG. 8B and FIG. 9A. The processor may continue to process subsequent intermediary chunks in parallel with the transmission of previous intermediary chunks.

With reference to the method 930, blocks 902-906 may be implemented by the processor in a similar manner as described herein for the method 900. In some aspects, the processor implementing blocks 902-906 may include a processing system (e.g., processing system 302, 322 in FIG. 2, FIG. 3A and FIG. 3B), a TX/RX module (e.g., TX/RX module 314 in FIG. 3A and FIG. 3B), or a distributed LXM execution module (e.g., distributed LXM execution module 316 in FIG. 3A and FIG. 3B).

In block 932, the processor may generate an output chunk (e.g., output probability 426 in FIG. 5A to FIG. 5F). An output chunk may be generated from a final intermediary chunk generated by the distributed AI computing device executing the allocated portion of the LXM, having one or more decoder layers (e.g., decoder layer 410, 412, 414, 416, 434, 434a, 434b, 434c, 434d in FIG. 5A to FIG. 5F), positioned in the LXM immediately preceding the one or more output layers (e.g., linear layers 422, softmax layer 424, output layers 434 in FIG. 5A to FIG. 5F). Processing the final intermediary chunk by execution of the one or more output layers of the portion of the LXM allocated to the distributed AI computing device may generate the output chunk. In some aspects, the processor generating the output chunk in block 932 may include the processor or the distributed LXM execution module.

In block 934, the processor may transmit an output. In some aspects, the processor may transmit the output directed to a computing device executing a client application (e.g., client application 502 in FIG. 5A to FIG. 5F) that initiated execution of the LXM or broadcast the output token to multiple computing devices. In some aspects, the output transmitted to the computing device executing the client application may be an output chunk. In some aspects, the processor may assemble the output chunks derived from an input (e.g., input 402, 602 in FIG. 5A to FIG. 5F, FIG. 6A, and FIG. 6B) into an output tensor. The output transmitted to the computing device executing the client application may be the output tensor. In some aspects, the computing device executing the client application may be the initial distributed AI computing device or another computing device. In some aspects, the processor transmitting the output in block 934 may include the processor or the TX/RX module.

The processor may serially receive and input the final intermediary chunks, repeatedly implementing blocks 902 and 904, and serially implement the layers of the LXM that the processor is configured to implement, repeatedly implementing blocks 906 and 932. The processor may also serially transmit generated output chunks to the computing device executing the client application, repeatedly implementing block 934. For example, the processor may implement the one or more decoder layers and one or more output layers for a first final intermediary chunk to generate a first output chunk. In parallel with transmitting the first output chunk to the computing device executing the client application, the processor may implement the one or more decoder layers and one or more output layers for a second final intermediary chunk to generate a second output chunk. The processor may also implement the one or more decoder layers and one or more output layers for the first final intermediary chunk in parallel with the initial distributed AI computing device or one or more distributed AI computing device implementing the distributed LXM for generating the second final intermediary chunk, as described further herein for the methods 820, 900, 920 with reference to FIG. 8B, FIG. 9A, and FIG. 9B. The processor may continue to process subsequent intermediary chunks in parallel with the transmission of previous intermediary chunks.

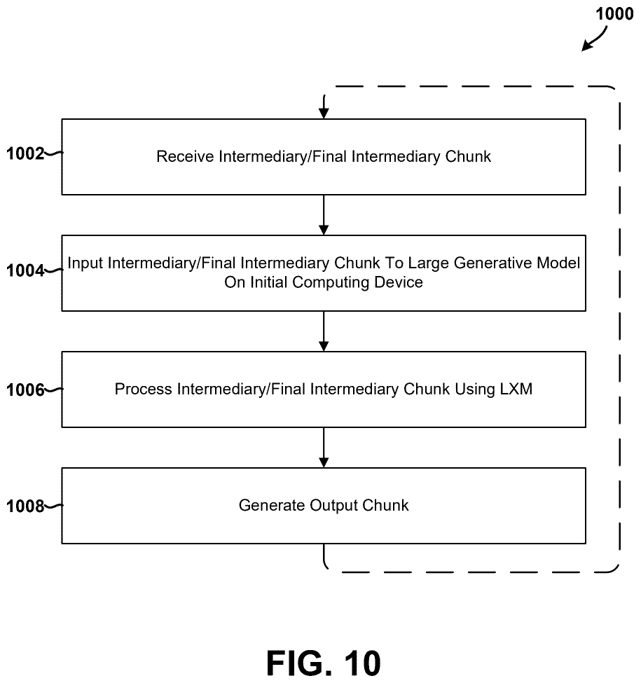

FIG. 10 is a process flow diagram illustrating a method 1000 for implementing an LXM (e.g., LXM 400 in FIG. 4) distributed across a cluster of computing devices (e.g., computing device 202, 204, 204a, 204b, 504, 604a, 604b, 604c in FIGS. 2-3B and 5A-6B) of a distributed AI computing system (e.g., distributed AI computing system 200, 200a, 200b, 200c, 200d, 200e, 200f in FIGS. 2-3B and 5A-5F) in accordance with some embodiments. With reference to FIGS. 1-10, the method 1000 may be performed in a computing device by at least one processing system including at least one memory having executable instructions thereon coupled to one or more processors configured to execute the executable instructions (e.g., processing system 302, 322 in FIGS. 1, 3A, and 3B) and components (e.g., module 308-316 in FIGS. 3A and 3B) or subsystems discussed in this application. Means for performing the functions of the operations in the method 1000 may include a processing system including one or more processors, at least one memory, and other components described herein. Further, one or more processors of a processing system may be configured with software or firmware to perform some or all of the operations of the method 1000. In order to encompass the alternative configurations enabled in various embodiments, the hardware implementing any or all of the method 1000 is referred to herein as a “processor.”

In block 1002, the processor may receive an intermediary chunk (e.g., C1-1, C2-1, C3-1, C4-1, C1-2, C2-2, C3-2, C4-2 in FIG. 6A and FIG. 6B). The processor of an initial distributed AI computing device may receive an intermediary chunk transmitted from a distributed AI computing device depending on the position in the LXM of the portion of the LXM allocated to the distributed AI computing device. For example, the intermediary chunk may be a final intermediary chunk. The final intermediary chunk may be received from a distributed AI computing device configured with a portion of the LXM, having one or more decoder layers (e.g., decoder layer 410, 412, 414, 416, 434, 434a, 434b, 434c, 434d in FIGS. 4-5F), positioned in the LXM immediately preceding the one or more output layers (e.g., linear layers 422, softmax layer 424, output layers 434 in FIGS. 4-5F). Based on a configuration of the initial distributed AI computing device to implement the distributed LXM, implementing the distributed LXM may include implementing the one or more decoder layers and/or the one or more output layers of the portion allocated to the initial distributed AI computing device. The processor of the initial distributed AI computing device configured for implementing the one or more decoder layers may receive an intermediary chunk transmitted from an initial distributed AI computing device or a different distributed AI computing device depending on the position in the LXM of the portion of the LXM allocated to the initial distributed AI computing device. The processor of the initial distributed AI computing device configured for implementing the one or more output layers may receive a final intermediary chunk transmitted from a different distributed AI computing device. In some embodiments, the processor receiving the intermediary chunk in block 1002 may include a processing system (e.g., processing system 302, 322 in FIGS. 1, 3A, and 3B) or a TX/RX module (e.g., TX/RX module 314 in FIG. 3A).

In block 1004, the processor may input the intermediary chunk to the LXM on the initial distributed AI computing device. The processor may serially input the intermediary chunks to one or more decoder layers of the LXM. In some embodiments, the processor may serially input the final intermediary chunk to one or more output layers of the LXM on the initial distributed AI computing device. In some embodiments, the processor inputting the intermediary chunk to the LXM on the initial distributed AI computing device in block 1004 may include the processor or a distributed LXM execution module (e.g., distributed LXM execution module 316 in FIG. 3A).

In block 1006, the processor may process the intermediary chunk using the LXM on the initial distributed AI computing device. Based on an indication of an allocated portion of the LXM, a configuration of the initial distributed AI computing device may be to implement the distributed LXM. In some embodiments, implementing the distributed LXM may include implementing the one or more decoder layers on the initial distributed AI computing device for the intermediary chunk and generating the final intermediary chunk. In some embodiments, implementing the distributed LXM may include implementing the one or more output layers on the initial distributed AI computing device for the final intermediary chunk. In some embodiments, the processor processing the intermediary chunk using LXM on the initial distributed AI computing device in block 1006 may include the processor or the distributed LXM execution module.

In block 1008, the processor may generate an output chunk (e.g., output probability 426 in FIGS. 4-5F). Processing the final intermediary chunk by execution of the one or more output layers may generate the output chunk. In some embodiments, the processor may assemble the output chunks derived from an input (e.g., input 402, 602 in FIGS. 4, 6A, and 6B) into an output tensor. In some embodiments, the processor generating the output chunk in block 1008 may include the processor or the distributed LXM execution module.

The processor may serially receive and input the intermediary chunks, repeatedly implementing blocks 1002 and 1004, and serially implement the layers of the LXM that the processor is configured to implement, repeatedly implementing blocks 1006 and 1008. For example, the processor may implement the one or more output layers for a first intermediary chunk to generate a first output chunk. The processor may also implement the one or more output layers for the first intermediary chunk in parallel with the initial distributed AI computing device or one or more distributed AI computing device implementing the distributed LXM for generating a second intermediary chunk, as described further herein for the methods 820, 900, 920 with reference to FIGS. 8B-9B.

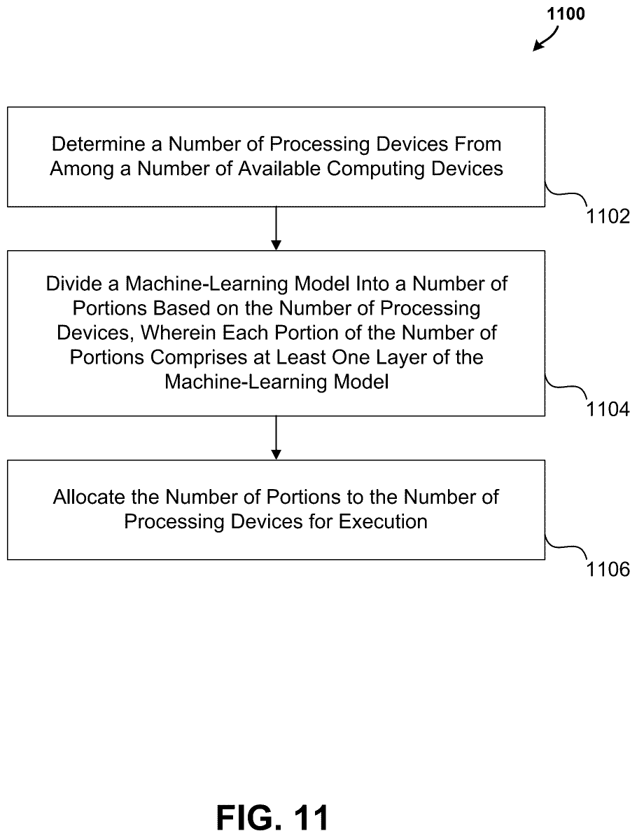

FIG. 11 is a flow diagram illustrating an example process 1100 for processing data, in accordance with aspects of the present disclosure. One or more operations of process 1100 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the one or more operations of process 1100. The one or more operations of process 1100 may be implemented as software components that are executed and run on one or more processors.

At block 1102, a computing device (or one or more components thereof) may determine a number of processing devices from among a number of available computing devices.

At block 1104, the computing device (or one or more components thereof) may divide a machine-learning model into a number of portions based on the number of processing devices, wherein each portion of the number of portions comprises at least one layer of the machine-learning model.

At block 1106, the computing device (or one or more components thereof) may allocate the number of portions to the number of processing devices for execution.

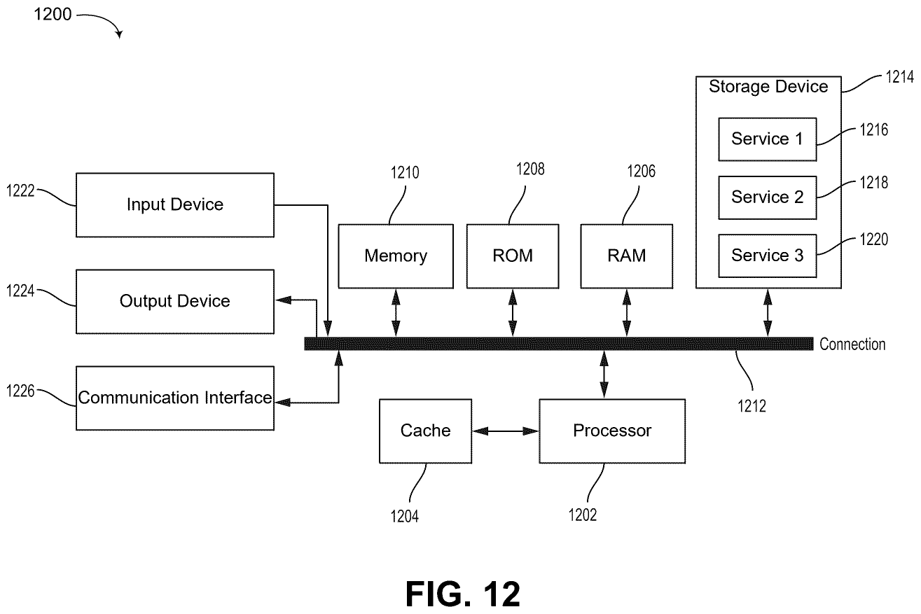

In some examples, as noted previously, the methods described herein (e.g., method 700 of FIG. 7A, method 710 of FIG. 7B, method 720 of FIG. 7C, method 800 of FIG. 8A, method 820 of FIG. 8B, method 900 of FIG. 9A, method 920 of FIG. 9B, method 1000 of FIG. 10, process 1100 of FIG. 11, and/or other methods described herein) can be performed, in whole or in part, by a computing device or apparatus. In one example, one or more of the methods can be performed by system 100 of FIG. 1, distributed AI computing system 200 of FIG. 2, FIG. 3A, and FIG. 3B, distributed AI computing system 200a of FIG. 5A, distributed AI computing system 200b of FIG. 5B, distributed AI computing system 200c of FIG. 5C, distributed AI computing system 200d of FIG. 5D, distributed AI computing system 200e of FIG. 5E, distributed AI computing system 200f of FIG. 5F, or by another system or device. In another example, one or more of the methods (e.g., method 700, method 710, method 720, method 800, method 820, method 900, method 920, method 1000, process 1100, and/or other methods described herein) can be performed, in whole or in part, by the computing-device architecture 1200 shown in FIG. 12. For instance, a computing device with the computing-device architecture 1200 shown in FIG. 12 can include, or be included in, the components of the system 100, distributed AI computing system 200, distributed AI computing system 200a, distributed AI computing system 200b, distributed AI computing system 200c, distributed AI computing system 200d, distributed AI computing system 200e, and/or distributed AI computing system 200, and can implement the operations of process 1100, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Method 700, method 710, method 720, method 800, method 820, method 900, method 920, method 1000, process 1100, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, method 700, method 710, method 720, method 800, method 820, method 900, method 920, method 1000, process 1100, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

FIG. 12 illustrates an example computing-device architecture 1200 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 1200 may include, implement, or be included in any or all of system 100 of FIG. 1, distributed AI computing system 200 of FIG. 2, FIG. 3A, and FIG. 3B, distributed AI computing system 200a of FIG. 5A, distributed AI computing system 200b of FIG. 5B, distributed AI computing system 200c of FIG. 5C, distributed AI computing system 200d of FIG. 5D, distributed AI computing system 200e of FIG. 5E, distributed AI computing system 200f of FIG. 5F and/or other devices, modules, or systems described herein. Additionally or alternatively, computing-device architecture 1200 may be configured to perform method 700 of FIG. 7A, method 710 of FIG. 7B, method 720 of FIG. 7C, method 800 of FIG. 8A, method 820 of FIG. 8B, method 900 of FIG. 9A, method 920 of FIG. 9B, method 1000 of FIG. 10, process 1100 of FIG. 11, and/or other process described herein.

The components of computing-device architecture 1200 are shown in electrical communication with each other using connection 1212, such as a bus. The example computing-device architecture 1200 includes a processing unit (CPU or processor) 1202 and computing device connection 1212 that couples various computing device components including computing device memory 1210, such as read only memory (ROM) 1208 and random-access memory (RAM) 1206, to processor 1202.

Computing-device architecture 1200 can include a cache of high-speed memory connected directly with, in close proximity to, or integrated as part of processor 1202. Computing-device architecture 1200 can copy data from memory 1210 and/or the storage device 1214 to cache 1204 for quick access by processor 1202. In this way, the cache can provide a performance boost that avoids processor 1202 delays while waiting for data. These and other modules can control or be configured to control processor 1202 to perform various actions. Other computing device memory 1210 may be available for use as well. Memory 1210 can include multiple different types of memory with different performance characteristics. Processor 1202 can include any general-purpose processor and a hardware or software service, such as service 1 1216, service 2 1218, and service 3 1220 stored in storage device 1214, configured to control processor 1202 as well as a special-purpose processor where software instructions are incorporated into the processor design. Processor 1202 may be a self-contained system, containing multiple cores or processors, a bus, memory controller, cache, etc. A multi-core processor may be symmetric or asymmetric.

To enable user interaction with the computing-device architecture 1200, input device 1222 can represent any number of input mechanisms, such as a microphone for speech, a touch-sensitive screen for gesture or graphical input, keyboard, mouse, motion input, speech and so forth. Output device 1224 can also be one or more of a number of output mechanisms known to those of skill in the art, such as a display, projector, television, speaker device, etc. In some instances, multimodal computing devices can enable a user to provide multiple types of input to communicate with computing-device architecture 1200. Communication interface 1226 can generally govern and manage the user input and computing device output. There is no restriction on operating on any particular hardware arrangement and therefore the basic features here may easily be substituted for improved hardware or firmware arrangements as they are developed.

Storage device 1214 is a non-volatile memory and can be a hard disk or other types of computer readable media which can store data that are accessible by a computer, such as magnetic cassettes, flash memory cards, solid state memory devices, digital versatile discs (DVDs), cartridges, random-access memories (RAMs) 1206, read only memory (ROM) 1208, and hybrids thereof. Storage device 1214 can include services 1216, 1218, and 1220 for controlling processor 1202. Other hardware or software modules are contemplated. Storage device 1214 can be connected to the computing device connection 1212. In one aspect, a hardware module that performs a particular function can include the software component stored in a computer-readable medium in connection with the necessary hardware components, such as processor 1202, connection 1212, output device 1224, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“>”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, such as, a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An apparatus for processing data, the apparatus comprising: at least one memory; and at least one processor coupled to the at least one memory and configured to: determine a number of processing devices from among a number of available computing devices; divide a machine-learning model into a number of portions based on the number of processing devices, wherein each portion of the number of portions comprises at least one layer of the machine-learning model; and allocate the number of portions to the number of processing devices for execution.

Aspect 2. The apparatus of aspect 1, wherein the number of processing devices are determined from among the number of available computing devices based on: an input length, a predicted output length; and a count of the number of available computing devices.

Aspect 3. The apparatus of any one of aspects 1 or 2, wherein the at least one processor is configured to process input data using a first portion of the number of portions at a first processing device of the number of processing devices to generate first processed data.

Aspect 4. The apparatus of aspect 3, wherein the at least one processor is configured to process processed data using the first portion at the first processing device to generate first output data.

Aspect 5. The apparatus of any one of aspects 1 to 4, wherein the at least one processor is configured to: determine a chunk size based on the number of available computing devices and an input length of an input; and divide tokens of the input into a number of chunks based on the chunk size.

Aspect 6. The apparatus of aspect 5, wherein the number of processing devices is determined based on the chunk size.

Aspect 7. The apparatus of any one of aspects 5 or 6, wherein the at least one processor is configured to process a first chunk of the number of chunks using a first portion of the number of portions at a first processing device of the number of processing devices to generate first processed data.

Aspect 8. The apparatus of aspect 7, wherein the at least one processor is configured to cause at least one transmitter to transmit the first processed data from the first processing device to a second processing device of the number of processing devices.

Aspect 9. The apparatus of aspect 8, wherein the at least one processor is configured to cause at least one transmitter to transmit, from the first processing device to the second processing device the chunk size.

Aspect 10. The apparatus of any one of aspects 8 or 9, wherein the second processing device is configured to estimate the chunk size based on at least one previously-received processed data.

Aspect 11. The apparatus of any one of aspects 1 to 10, wherein the at least one processor is configured to: determine a first chunk size based on the number of available computing devices and an input length; divide tokens of an input into a number of first chunks based on the first chunk size; and process a first chunk of the number of first chunks using a first portion of the number of portions at a first processing device of the number of processing devices to generate first processed data.

Aspect 12. The apparatus of aspect 11, wherein the at least one processor is configured to: determine a second chunk size based on a draft token size; divide processed data into a number of second chunks based on the second chunk size; and process a first chunk of the number of second chunks using the first portion at the first processing device to generate first output data.

Aspect 13. The apparatus of aspect 12, wherein the second chunk size is determined based on a determination that the number of second chunks will be processed using a speculative-decoding technique.

Aspect 14. The apparatus of any one of aspects 1 to 13, wherein the number of processing devices comprises a number of first processing devices, wherein the number of portions comprises a number of first portions, wherein the at least one processor is configured to: determine a number of second processing devices from among the number of available computing devices; divide the machine-learning model into a number of second portions based on the number of second processing devices, wherein each portion of the number of second portions comprises at least one layer of the machine-learning model; and allocate the number of second portions to the number of second processing devices for execution.

Aspect 15. The apparatus of aspect 14, wherein a count of the number of first processing devices is greater than or less than a count of the number of second processing devices.

Aspect 16. The apparatus of any one of aspects 14 or 15, wherein the at least one processor is configured to: process input data using a portion of the number of first portions at a first processing device of the number of processing devices to generate first processed data; and process processed data using a portion of the number of second portions at the first processing device to generate first output data.

Aspect 17. The apparatus of any one of aspects 14 to 16, wherein the number of first processing devices are configured to transmit keys and values to the number of second processing devices while the number of first processing devices are processing data.

Aspect 18. The apparatus of any one of aspects 1 to 17, wherein, to allocate the number of portions to the number of processing devices, the at least one processor is configured to instruct each of the number of processing devices to load a corresponding portion of the number of portions.

Aspect 19. The apparatus of any one of aspects 1 to 18, wherein, to divide the machine-learning model into the number of portions, the at least one processor is configured to divide the machine-learning model into portion of unequal sizes based on processing capabilities of the number of processing devices.

Aspect 20. The apparatus of any one of aspects 1 to 19, wherein the machine-learning model comprises a large generative machine-learning model.

Aspect 21. A method for processing data, the method comprising: determining a number of processing devices from among a number of available computing devices; dividing a machine-learning model into a number of portions based on the number of processing devices, wherein each portion of the number of portions comprises at least one layer of the machine-learning model; and allocating the number of portions to the number of processing devices for execution.

Aspect 22. The method of aspect 21, wherein the number of processing devices are determined from among the number of available computing devices based on: an input length, a predicted output length; and a count of the number of available computing devices.

Aspect 23. The method of any one of aspects 21 or 22, further comprising processing input data using a first portion of the number of portions at a first processing device of the number of processing devices to generate first processed data.

Aspect 24. The method of aspect 23, further comprising processing processed data using the first portion at the first processing device to generate first output data.

Aspect 25. The method of any one of aspects 21 to 24, further comprising: determining a chunk size based on the number of available computing devices and an input length of an input; and dividing tokens of the input into a number of chunks based on the chunk size.

Aspect 26. The method of aspect 25, wherein the number of processing devices is determined based on the chunk size.

Aspect 27. The method of any one of aspects 25 or 26, further comprising processing a first chunk of the number of chunks using a first portion of the number of portions at a first processing device of the number of processing devices to generate first processed data.

Aspect 28. The method of aspect 27, further comprising transmitting the first processed data from the first processing device to a second processing device of the number of processing devices.

Aspect 29. The method of aspect 28, further comprising transmitting, from the first processing device to the second processing device the chunk size.

Aspect 30. The method of any one of aspects 28 or 29, wherein the second processing device is configured to estimate the chunk size based on at least one previously-received processed data.

Aspect 31. The method of any one of aspects 21 to 30, further comprising: determining a first chunk size based on the number of available computing devices and an input length; dividing tokens of an input into a number of first chunks based on the first chunk size; and processing a first chunk of the number of first chunks using a first portion of the number of portions at a first processing device of the number of processing devices to generate first processed data.

Aspect 32. The method of aspect 31, further comprising: determining a second chunk size based on a draft token size; dividing processed data into a number of second chunks based on the second chunk size; and processing a first chunk of the number of second chunks using the first portion at the first processing device to generate first output data.

Aspect 33. The method of aspect 32, wherein the second chunk size is determined based on a determination that the number of second chunks will be processed using a speculative-decoding technique.

Aspect 34. The method of any one of aspects 21 to 33, wherein the number of processing devices comprises a number of first processing devices, wherein the number of portions comprises a number of first portions, the method further comprising: determining a number of second processing devices from among the number of available computing devices; dividing the machine-learning model into a number of second portions based on the number of second processing devices, wherein each portion of the number of second portions comprises at least one layer of the machine-learning model; and allocating the number of second portions to the number of second processing devices for execution.

Aspect 35. The method of aspect 34, wherein a count of the number of first processing devices is greater than or less than a count of the number of second processing devices.

Aspect 36. The method of any one of aspects 34 or 35, further comprising: processing input data using a portion of the number of first portions at a first processing device of the number of processing devices to generate first processed data; and processing processed data using a portion of the number of second portions at the first processing device to generate first output data.

Aspect 37. The method of any one of aspects 24 to 36, wherein the number of first processing devices are configured to transmit keys and values to the number of second processing devices while the number of first processing devices are processing data.

Aspect 38. The method of any one of aspects 21 to 37, wherein allocating the number of portions to the number of processing devices comprises instructing each of the number of processing devices to load a corresponding portion of the number of portions.

Aspect 39. The method of any one of aspects 21 to 38, wherein dividing the machine-learning model into the number of portions comprises dividing the machine-learning model into portion of unequal sizes based on processing capabilities of the number of processing devices.

Aspect 40. The method of any one of aspects 21 to 39, wherein the machine-learning model comprises a large generative machine-learning model.

Aspect 41. A non-transitory computer-readable storage medium having stored thereon instructions that, when executed by at least one processor, cause the at least one processor to perform operations according to any of aspects 21 to 40.

Aspect 42. An apparatus for providing virtual content for display, the apparatus comprising one or more means for perform operations according to any of aspects 21 to 40.

What is claimed is:

1. An apparatus for processing data, the apparatus comprising:
at least one memory; and
at least one processor coupled to the at least one memory and configured to:
determine a number of processing devices from among a number of available computing devices;
divide a machine-learning model into a number of portions based on the number of processing devices, wherein each portion of the number of portions comprises at least one layer of the machine-learning model; and
allocate the number of portions to the number of processing devices for execution.

2. The apparatus of claim 1, wherein the number of processing devices are determined from among the number of available computing devices based on:
an input length,
a predicted output length; and
a count of the number of available computing devices.

3. The apparatus of claim 1, wherein the at least one processor is configured to process input data using a first portion of the number of portions at a first processing device of the number of processing devices to generate first processed data.

4. The apparatus of claim 3, wherein the at least one processor is configured to process processed data using the first portion at the first processing device to generate first output data.

5. The apparatus of claim 1, wherein the at least one processor is configured to:
determine a chunk size based on the number of available computing devices and an input length of an input; and
divide tokens of the input into a number of chunks based on the chunk size.

6. The apparatus of claim 5, wherein the number of processing devices is determined based on the chunk size.

7. The apparatus of claim 5, wherein the at least one processor is configured to process a first chunk of the number of chunks using a first portion of the number of portions at a first processing device of the number of processing devices to generate first processed data.

8. The apparatus of claim 7, wherein the at least one processor is configured to cause at least one transmitter to transmit the first processed data from the first processing device to a second processing device of the number of processing devices.

9. The apparatus of claim 8, wherein the at least one processor is configured to cause at least one transmitter to transmit, from the first processing device to the second processing device the chunk size.

10. The apparatus of claim 8, wherein the second processing device is configured to estimate the chunk size based on at least one previously-received processed data.

11. The apparatus of claim 1, wherein the at least one processor is configured to:
determine a first chunk size based on the number of available computing devices and an input length;
divide tokens of an input into a number of first chunks based on the first chunk size; and
process a first chunk of the number of first chunks using a first portion of the number of portions at a first processing device of the number of processing devices to generate first processed data.

12. The apparatus of claim 11, wherein the at least one processor is configured to:
determine a second chunk size based on a draft token size;
divide processed data into a number of second chunks based on the second chunk size; and
process a first chunk of the number of second chunks using the first portion at the first processing device to generate first output data.

13. The apparatus of claim 12, wherein the second chunk size is determined based on a determination that the number of second chunks will be processed using a speculative-decoding technique.

14. The apparatus of claim 1, wherein the number of processing devices comprises a number of first processing devices, wherein the number of portions comprises a number of first portions, wherein the at least one processor is configured to:
determine a number of second processing devices from among the number of available computing devices;
divide the machine-learning model into a number of second portions based on the number of second processing devices, wherein each portion of the number of second portions comprises at least one layer of the machine-learning model; and
allocate the number of second portions to the number of second processing devices for execution.

15. The apparatus of claim 14, wherein a count of the number of first processing devices is greater than or less than a count of the number of second processing devices.

16. The apparatus of claim 14, wherein the at least one processor is configured to:
process input data using a portion of the number of first portions at a first processing device of the number of processing devices to generate first processed data; and
process processed data using a portion of the number of second portions at the first processing device to generate first output data.

17. The apparatus of claim 14, wherein the number of first processing devices are configured to transmit keys and values to the number of second processing devices while the number of first processing devices are processing data.

18. The apparatus of claim 1, wherein, to allocate the number of portions to the number of processing devices, the at least one processor is configured to instruct each of the number of processing devices to load a corresponding portion of the number of portions.

19. The apparatus of claim 1, wherein, to divide the machine-learning model into the number of portions, the at least one processor is configured to divide the machine-learning model into portion of unequal sizes based on processing capabilities of the number of processing devices.

20. The apparatus of claim 1, wherein the machine-learning model comprises a large generative machine-learning model.
